(19) United States
(12) Patent Application Publication
(10) Pub. No.: US 2026/0138091 A1
(43) Pub. Date: May 21, 2026

(54) HYBRID FRESHWATER GENERATION AND AIR CONDITIONING SYSTEM

(71) Applicant: KING FAHD UNIVERSITY OF PETROLEUM AND MINERALS, Dhahran (SA)

(72) Inventors: Atia Esmaeil Atia KHALIFA, Dhahran (SA); Suhaib Mustafa Alawad AHMED, Dhahran (SA); Mohamed Abdallah Fahmy KOTB, Dhahran (SA); Dahiru Umar LAWAL, Dhahran (SA); Mohamed Abdelkarim ANTAR, Dhahran (SA)

(73) Assignee: KING FAHD UNIVERSITY OF PETROLEUM AND MINERALS, Dhahran (SA)

(21) Appl. No.: 18/949,669

(22) Filed: Nov. 15, 2024

(51) Int. Cl. B01D 61/36; B01D 53/14; B01D 53/18; B01D 53/26; B01D 53/28; C02F 1/44; C02F 103/08; F24F 6/00

(52) U.S. Cl. CPC B01D 61/366; B01D 53/1493; B01D 53/185; B01D 53/263; B01D 53/28; B01D 61/364; B01D 61/368; C02F 1/447; F24F 6/00; B01D 2252/103; B01D 2257/80; C02F 2103/08; C02F 2201/009; C02F 2301/046; F24F 2006/006

(57) ABSTRACT

A hybrid freshwater generation and air conditioning system, including a sweeping gas membrane distillation (SGMD) unit, which includes a liquid side having a liquid inlet, a liquid outlet, and a porous hydrophobic membrane, and a bubble dehumidifier unit which includes a gas inlet connected to the gas outlet of the vapor side of the SGMD unit, a gas outlet, a freshwater inlet, a freshwater outlet, a recirculation outlet, a recirculation cooler, and a recirculation inlet. The system is configured to contain a saltwater in the liquid side and pass a gas over the membrane of the SGMD unit to produce a humidified gas. The bubble dehumidifier unit passes the humidified gas through a freshwater in the form of bubbles, thereby producing a dehumidified gas. The dehumidified gas can be cooled and provided as air conditioning to an interior space.

### BACKGROUND

### TECHNICAL FIELD

The present disclosure is directed to the field of water purification and space conditioning technologies. More specifically, the present disclosure relates to a hybrid freshwater generation and air conditioning system integrating a sweeping gas membrane distillation (SGMD) unit and a multi-effect bubble dehumidifier unit for efficient water purification and air conditioning processes.

### DESCRIPTION OF RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Water scarcity is one of the most pressing challenges of present days, driven by factors such as population growth, urbanization, and climate change. As freshwater resources become increasingly strained, societies around the world are seeking sustainable and efficient methods to secure reliable water supplies. Desalination, which is the process of removing salts and other minerals from seawater or brackish water, has emerged as a critical technology to augment freshwater resources. However, traditional desalination techniques such as reverse osmosis and thermal distillation often come with substantial energy costs, significant environmental impacts, and in some cases, produce brine by-products that pose disposal challenges. As a result, there has been an increasing interest in developing more energy-efficient, environmentally friendly, and cost-effective desalination technologies.

One promising approach is membrane distillation (MD), a thermal desalination process that leverages a hydrophobic membrane to separate water vapor from a temperature-elevated seawater feed stream via an induced vapor pressure difference across the membrane surfaces. MD systems have many conventional configurations, including direct contact membrane distillation (DCMD), vacuum membrane distillation (VMD), sweeping gas membrane distillation (SGMD), and air gap membrane distillation (AGMD). MD systems operate at lower pressures, have high rejection factors for solutes and impurities, and may operate with low-grade heat sources such as waste heat or solar energy. MD systems are modular and highly scalable and may be integrated with other water treatment processes. In addition, MD systems may be integrated with different thermal engineering applications to exchange and utilize waste heat for economic operation.

Among various MD configurations, sweeping gas membrane distillation (SGMD) has shown promising performance. In SGMD, a hot feed stream and a gas stream (normally air) are separated by a hydrophobic membrane. The vapor pressure difference between the hot feed stream and the gas stream across the membrane causes water vapor of the hot feed stream to travel through the membrane pores and into the sweeping gas stream flowing on the other side of the membrane. The larger the temperature difference between the feed and sweeping gas sides, the higher the vapor pressure difference, leading to increased water flux across the membrane.

In the sweeping gas membrane distillation process the gas becomes humidified after sweeping the water vapor. The gas is normally dehumidified in a heat exchanger to condense the water vapor and produce purified water. One such technology for dehumidifying a gas is using a bubble column dehumidifier (BCD), characterized by high effectiveness in removing moisture from the air during a heat and mass transfer process of air bubbles moving in a low-temperature water column. In this process, a humid air stream is sparged into a water column to generate bubbles of the humid air. The water column is set at a temperature lower than the temperature of the humid air. The temperature and concentration gradients between the bubble and the water column allow the moisture in the air to condense in the water as it passes through the column. Further, the dehumidified air produced by the bubble dehumidifier has lower temperature than the input humid air stream, as such, it may be used to fulfill air conditioning requirements.

A challenge with bubble column dehumidifiers, however, is that the liquid through which the humidified gas bubbles must absorb heat from the humidified gas in order to cool it. Thus, the bubble column must either have the liquid heat up, losing efficiency, or a new supply of cold liquid be supplied, increasing the operation cost and decreasing the freshwater production. As the purified water from the humidified gas condenses in the liquid in the bubble column, purified water must be used. If, for example, salt water is used, the purified water would wind up merely diluting the saltwater, defeating the purpose of desalination.

In addition to water purification, there is also a growing demand for energy-efficient air conditioning technologies. Conventional air conditioning technologies, such as vapor compression refrigeration, are energy-intensive and use refrigerants that may have a high global warming potential. Therefore, there is a need for more energy-efficient, and environmentally friendly cooling technologies.

Therefore, the search for efficient, sustainable, and environmentally friendly water purification and air conditioning technologies is a pressing issue in the context of water scarcity and energy efficiency. There are existing technologies in both areas, however, each has its weaknesses.

U.S. Pat. No. 11,306,009B2 discloses desalination device including a membrane distillation module having a water feed chamber, a carrier gas (CG) chamber, and a hydrophobic microporous membrane configured to separate the water feed chamber and the CG chamber. A bubble column dehumidifier includes a bubble column inlet, a bubble column gas outlet, and a product outlet. The MD module allows water vapor to translocate to the CG chamber, but not liquid water. The water feed in each chamber includes a water feed inlet and a water feed outlet. The CG chamber includes a CG chamber inlet and CG chamber outlet, where the CG chamber outlet is upstream of and connected to the bubble column dehumidifier, and where the CG chamber inlet is downstream of and connected to the bubble column dehumidifier so as to allow a carrier gas to pass through the CG chamber and the bubble column dehumidifier. However, the reference provides a cooler to directly cool the liquid in the bubble column dehumidifier. Further, the reference recycles the sweeping gas in a closed loop.

U.S. Pat. No. 11,413,581B2 discloses devices and techniques that may improve the permeate productivity in membrane distillation separation by modifying the feed and/or coolant sides of a membrane distillation module depending on the membrane distillation configuration. The bubbling of a carrier gas through the feed liquid in the feed liquid side of the module may increase the turbulent dissipation rate and/or enhance mass transfer across the membrane pores. However, this reference also recycles the sweeping gas in a closed loop.

U.S. Pat. No. 8,460,551B2 discloses a water distillation system including a membrane distillation unit which produces desalinated water from seawater feed. The system also includes a primary water heater which raises the temperature of the feed water upstream of the feed water entering the membrane distillation unit. The system additionally includes an evaporative cooler which lowers the temperature of a coolant upstream of the coolant entering the membrane distillation unit. However, the reference does not use sweeping gas membrane distillation.

Each of the aforementioned references suffers from one or more drawbacks hindering their adoption.

Accordingly, it is one object of the present disclosure to provide a hybrid freshwater generation and air conditioning system integrating SGMD and BCD to enhance the energy efficiency, environmental performance, and cost-effectiveness of water purification and air conditioning technologies.

### SUMMARY

According to the first aspect, a hybrid freshwater generation and air conditioning system is described. In some embodiments, the system includes a sweeping gas membrane distillation unit, which includes a liquid side having a liquid inlet, a liquid outlet, and a porous hydrophobic membrane. In some embodiments, the sweeping gas membrane distillation unit further includes a vapor side having a gas inlet and a gas outlet, where the liquid side is separated from the vapor side by the porous hydrophobic membrane. In some embodiments, the system further includes a bubble dehumidifier unit. In some embodiments, the bubble dehumidifier unit includes a gas inlet connected to the gas outlet of the vapor side of the sweeping gas membrane distillation unit, a gas outlet, a freshwater inlet, a freshwater outlet, a recirculation outlet, a recirculation cooler, and a recirculation inlet. In some embodiments, the hybrid freshwater generation and air conditioning system is configured to contain a saltwater in the liquid side and pass a gas over the porous hydrophobic membrane in the vapor side of the sweeping gas membrane distillation unit to produce a humidified gas. In some embodiments, the bubble dehumidifier unit is configured to pass the humidified gas through a freshwater in the form of bubbles, thereby producing a dehumidified gas. In some embodiments, the bubble dehumidifier unit is configured to recirculate the freshwater through the recirculation outlet to the recirculation cooler, cool the freshwater to produce a cooled water, and provide the cooled water to the freshwater contained in the bubble dehumidifier unit.

In some embodiments, the recirculation cooler is at least one selected from a thermoelectric cooler, a cooling tower, and a heat exchanger.

In some embodiments, the recirculation inlet includes a spray nozzle disposed at a top of the bubble dehumidifier unit and is configured to spray the cooled water into the bubble dehumidifier unit such that the cooled water contacts the dehumidified gas.

In some embodiments, the hybrid freshwater generation and air conditioning system further includes a photovoltaic electricity generating unit configured to provide electricity to the hybrid freshwater generation and air conditioning system.

In some embodiments, the hybrid freshwater generation and air conditioning system further includes a dehumidified air cooler configured to cool the dehumidified gas exiting the bubble dehumidifier unit thereby producing a cooled gas.

In some embodiments, the dehumidified air cooler includes an auxiliary freshwater tank configured to collect freshwater produced by the cooling of the dehumidified gas.

In some embodiments, the hybrid freshwater generation and air conditioning system includes a plurality of bubble dehumidifier units connected in series such that the gas inlet of a first bubble dehumidifier unit is connected to the gas outlet of the vapor side of the sweeping gas membrane distillation unit and the gas inlet of each other bubble dehumidifier unit is connected to the gas outlet of a preceding bubble dehumidifier unit.

In some embodiments, the bubble dehumidifier unit includes a vapor trap disposed at the top of the bubble dehumidifier unit.

In some embodiments, the vapor trap is configured to be cooled to a temperature below the temperature of the dehumidified gas.

In some embodiments, the gas is air.

The present disclosure is also related to a hybrid freshwater generation and air conditioning system. In some embodiments, the system includes a sweeping gas membrane distillation unit, which includes a liquid side having a liquid inlet, a liquid outlet, and a porous hydrophobic membrane. In some embodiments, the sweeping gas membrane distillation unit further includes a vapor side including a gas inlet and a gas outlet, where the liquid side is separated from the vapor side by the porous hydrophobic membrane. In some embodiments, the system further includes a plurality of bubble dehumidifier units, each including a gas inlet connected to the gas outlet of the vapor side of the sweeping gas membrane distillation unit. In some embodiments, the plurality of bubble dehumidifier units further includes a gas outlet, a freshwater inlet, and a freshwater outlet. In some embodiments, the hybrid freshwater generation and air conditioning system is configured to contain a saltwater in the liquid side and pass a gas over the porous hydrophobic membrane in the vapor side of the sweeping gas membrane distillation unit to produce a humidified gas. In some embodiments, each bubble dehumidifier unit is configured to pass the humidified gas through a freshwater in the form of bubbles, thereby producing a dehumidified gas. In some embodiments, the plurality of bubble dehumidifier units is connected in series such that the gas inlet of a first bubble dehumidifier unit is connected to the gas outlet of the vapor side of the sweeping gas membrane distillation unit and the gas inlet of each other bubble dehumidifier unit is connected to the gas outlet of a preceding bubble dehumidifier unit. In some embodiments, each bubble dehumidifier unit contains a different amount of freshwater, the amount of freshwater being greater than a subsequent bubble dehumidifier unit in series and less than a preceding bubble dehumidifier unit in series.

In some embodiments, the hybrid freshwater generation and air conditioning system includes a photovoltaic electricity generating unit configured to provide electricity to the hybrid freshwater generation and air conditioning system.

In some embodiments, the hybrid freshwater generation and air conditioning system includes a dehumidified air cooler configured to cool the dehumidified gas exiting a final bubble dehumidifier unit thereby producing a cooled gas.

In some embodiments, the dehumidified air cooler includes an auxiliary freshwater tank configured to collect freshwater produced by the cooling of the dehumidified gas.

In some embodiments, each bubble dehumidifier unit further includes a recirculation outlet, a recirculation cooler, and a recirculation inlet. In some embodiments, each bubble dehumidifier unit is configured to recirculate the freshwater through the recirculation outlet to the recirculation cooler, cool the freshwater to produce a cooled water, and provide the cooled water to the freshwater contained in the bubble dehumidifier unit.

In some embodiments, the recirculation cooler is at least one selected from a thermoelectric cooler, a cooling tower, and a heat exchanger.

In some embodiments, the recirculation inlet includes a spray nozzle disposed at a top of the bubble dehumidifier unit and is configured to spray the cooled water into the bubble dehumidifier unit such that the cooled water contacts the dehumidified gas.

In some embodiments, each bubble dehumidifier unit includes a vapor trap disposed at the top of the bubble dehumidifier unit.

In some embodiments, the vapor trap is configured to be cooled to a temperature below the temperature of the dehumidified gas.

In some embodiments, the gas is air.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic diagram of a hybrid freshwater generation and air conditioning system integrating a sweeping gas membrane distillation (SGMD) unit and a bubble dehumidifier unit, according to certain embodiments;

FIG. 1B is a schematic diagram of a dehumidified air cooler including a plurality of thermoelectric coolers and an auxiliary freshwater tank, according to certain embodiments;

FIG. 2 is a schematic diagram of a hybrid freshwater generation and air conditioning system integrating a SGMD unit and a plurality of bubble dehumidifier units with external cooling fins, according to certain embodiments;

FIG. 3 is a schematic diagram of a hybrid freshwater generation and air conditioning system integrating a SGMD unit and a plurality of bubble dehumidifier units configured with a spray nozzle for each of the plurality of bubble dehumidifier units at a top thereof, and a recirculation cooler, according to certain embodiments;

FIG. 4 is a schematic diagram of a hybrid freshwater generation and air conditioning system integrating a SGMD unit and a plurality of bubble dehumidifier units configured with a vapor trap for each of the plurality of bubble dehumidifier units, and a recirculation cooler, according to certain embodiments;

FIG. 5 is a schematic diagram of a hybrid freshwater generation and air conditioning system integrating a SGMD unit and a plurality of bubble dehumidifier units configured with a solar powered thermoelectric cooler for each of the plurality of bubble dehumidifier units, and a control unit, according to certain embodiments;

FIG. 6 is a schematic diagram of a hybrid freshwater generation and air conditioning system integrating a SGMD unit and a horizontal multi-effect bubble dehumidifier unit including a cooling tower, according to certain embodiments;

FIG. 7A is a schematic perspective diagram of a hybrid freshwater generation and air conditioning system integrating a SGMD unit and a plurality of bubble dehumidifier units, with varying water levels, arranged in a vertical configuration, according to certain embodiments;

FIG. 7B is a schematic diagram of the hybrid freshwater generation and air conditioning system of FIG. 7A, according to certain embodiments;

FIG. 8A is a schematic perspective diagram of a hybrid freshwater generation and air conditioning system integrating a SGMD unit and a plurality of bubble dehumidifier units, with varying water levels, arranged in a horizontal configuration, according to certain embodiments;

FIG. 8B is a schematic diagram of the hybrid freshwater generation and air conditioning system of FIG. 8A, according to certain embodiments;

FIG. 9A is a schematic diagram of an experimental setup depicting a hybrid freshwater generation and air conditioning system integrating a SGMD unit and a plurality of bubble dehumidifier units, arranged in a horizontal series configuration, according to certain embodiments;

FIG. 9B is a partial perspective view of the hybrid freshwater generation and air conditioning system of FIG. 9A, according to certain embodiments;

FIG. 10A is a graph depicting temperature of processed air after each unit of the plurality of bubble dehumidifier units of the hybrid freshwater generation and air conditioning system of FIG. 9A, according to certain embodiments;

FIG. 10B is a graph depicting humidity ratio (ω) of the processed air after each unit of the plurality of bubble dehumidifier units of the hybrid freshwater generation and air conditioning system of FIG. 9A, according to certain embodiments;

FIG. 10C is a graph depicting freshwater production volume (flux) after each unit of the plurality of bubble dehumidifier units of the hybrid freshwater generation and air conditioning system of FIG. 9A, according to certain embodiments;

FIG. 11 is an illustration of a non-limiting example of details of computing hardware used in a computing system of the hybrid freshwater generation and air conditioning system, according to certain embodiments;

FIG. 12 is an exemplary schematic diagram of a data processing system used within the computing system, according to certain embodiments;

FIG. 13 is an exemplary schematic diagram of a processor used with the computing system, according to certain embodiments; and

FIG. 14 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to a hybrid freshwater generation and air conditioning system which integrates a sweeping gas membrane distillation (SGMD) unit and a bubble dehumidifier unit.

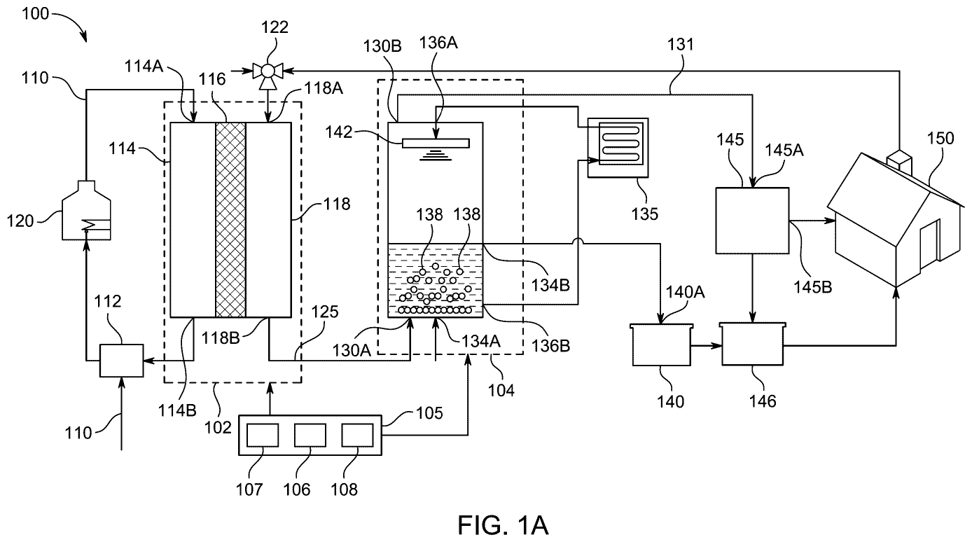

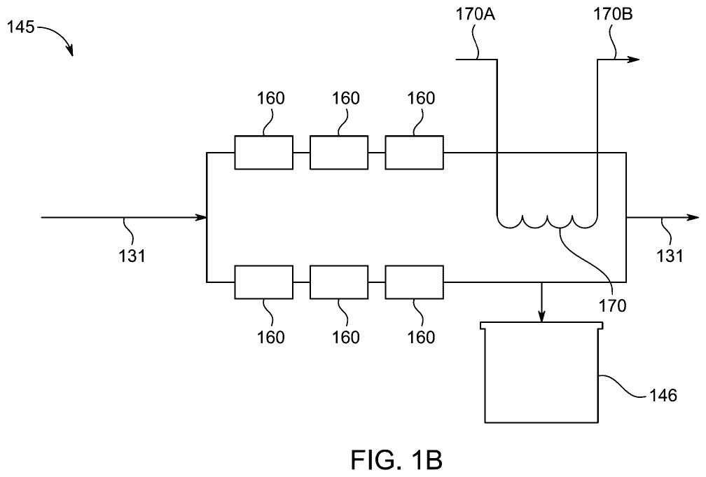

Referring to FIG. 1A, illustrated is a hybrid freshwater generation and air conditioning system 100 that integrates a sweeping gas membrane distillation (SGMD) unit 102 and a bubble dehumidifier unit 104, otherwise referred to as ‘the bubble column dehumidifier (BCD) unit 104’ according to an exemplary embodiment of the present disclosure. The hybrid freshwater generation and air conditioning system 100 may be, hereinafter, referred to as ‘the hybrid system 100’ without any limitations. In some embodiments, the hybrid system 100 utilizes and combines principles of thermodynamic cycles and heat and mass transfer to create a looped system that generates freshwater via the SGMD unit 102 and also provides air conditioning via the bubble dehumidifier unit 104. In some embodiments, the SGMD unit 102 may be responsible for the desalination process. In addition, in some embodiments, the bubble dehumidifier unit 104 may be responsible for the thermal management processes, utilizing a cooled water column to absorb, transfer, and release heat and moisture out of input feed stream, in a cyclic manner. Further, to reduce carbon footprint and improve environmental compatibility of the hybrid system 100, it is, in some embodiments, configured to be operated by solar energy. As such, in some embodiments, a photovoltaic electricity generating unit 105, configured to provide electricity to the hybrid system 100, is electrically and operationally coupled with the hybrid system 100. In an embodiment, the photovoltaic electricity generating unit 105 may include a photovoltaic cell array 106, an energy storage unit 107, and a control unit 108. The energy storage unit 107 may store generated electricity (e.g., electricity generated by the photovoltaic cell array 106) for current and forecasted use. In some embodiments, the control unit 108 may control an amount of electricity being supplied to the hybrid system 100. In some embodiments, the control unit 108 may enable or disable power supply to one or more components included in the hybrid system 100 based on a cooling and freshwater demand, in order to preserve energy and reduce adverse environmental effect. Thereby, in certain embodiments, the hybrid system 100 of the present disclosure provides solutions for freshwater generation and air conditioning by integrating the functionalities and leveraging the synergies of the SGMD unit 102 and the bubble dehumidifier unit 104, to enhance energy efficiency and productivity.

As illustrated in FIG. 1A, the exemplary SGMD unit 102 is responsible for generating freshwater from a feed stream 110. In some embodiments, the SGMD unit 102 performs desalination of the feed stream 110. In some embodiments, the hybrid system 100 is designed to treat the feed stream 110, which may be pumped via a feed pump 112, and the feed pump 112 may be fluidly connected in an open loop with a source of the feed stream 110 and the hybrid system 100. In an embodiment, the feed stream 110 includes a saltwater. In general, the feed stream 110 may include any wastewater, saltwater, or brackish water that may need water purification and treatment.

The exemplary SGMD unit 102 depicted in FIG. 1A includes a liquid side 114 having a liquid inlet 114A fluidly disposed at a top end of the liquid side 114 and a liquid outlet 114B fluidly disposed at a bottom end of the liquid side 114. The liquid inlet 114A and the liquid outlet 114B are openings to let the feed stream 110 in and out, respectively, of the SGMD unit 102. In some embodiments, each of the liquid inlet 114A and the liquid outlet 114B may include an angle valve (not shown) to restrict flow of the feed stream 110 when required to perform scheduled and unscheduled maintenance on the SGMD unit 102. In some embodiments, the SGMD unit 102 of the hybrid system 100 further includes a porous hydrophobic membrane 116, alternatively referred to as ‘the membrane 116’ hereinafter, for the sake of brevity in explanation. The exemplary SGMD unit 102 includes a vapor side 118. Herein, the liquid side 114 is configured to receive the feed stream 110 including unpurified water, usually, in a heated state (and thus also referred to as hot stream or hot feed stream, without any limitations). In some embodiments, the hybrid system 100 is configured to contain a saltwater (which should be understood to include a seawater, a non-seawater water containing a salt such as an oil or gas formation brine, a wastewater, and a brackish water). In some embodiments, the heating of the feed stream 110 is performed by an external water heater 120. In some embodiments, the external water heater may be configured to be coupled in a closed loop with the liquid side 114, and thermally and fluidly coupled with the liquid inlet 114A and the liquid outlet 114B of the liquid side 114. In some embodiments, the vapor side 118 also receives the feed stream 110 including water vapors processed by the membrane 116, usually, in a cooled state (and thus also referred to as cold stream or cold feed stream, without any limitations). The membrane 116, which includes a plurality of pores, is disposed between the liquid side 114 and the vapor side 118. The liquid side 114 and the vapor side 118 are separated by the porous hydrophobic membrane 116. In some embodiments, the membrane 116 may include any one of a composite membrane, a nano-composite membrane, a hydrophobic membrane, an omni phobic membrane, a hydrophilic and hydrophobic composite dual layer membrane, a modified ceramic membrane, a porous ceramic membrane, a surface modified membrane, a polymer electrolyte membrane, a porous graphene membrane, a polymeric membrane, or combinations of these. In some embodiments, a contact angle of a droplet of the feed stream 110 on the membrane 116 is at least 90 degrees, preferably at least 100 degrees, preferably at least 110 degrees, preferably at least 115 degrees, preferably at least 120 degrees, preferably at least 125 degrees.

In some embodiments, the feed stream 110 from the liquid side 114 flows over the surface of the membrane 116, where water vapor is generated at the membrane-feed water interface. The pores in the membrane 116 allow water vapors, originating from the feed stream 110, to pass from the liquid side 114 through the membrane 116 to the vapor side 118. Specifically, the membrane 116, with its selective permeability (water impervious but vapor permeable), allows only water vapor to pass through, effectively separating the water from the other contaminants present in the feed stream 110. In some embodiments, the driving force for vapor permeation across the membrane 116 is caused by or augmented by the sweeping gas pressure and/or flowrate difference (lower than the permeate side) between the liquid and vapor sides 114, 118 of the membrane 116, as created by a sweeping gas present in the vapor side 118. In some embodiments, the sweeping gas is delivered to the vapor side 118 through a three-way valve 122 via a gas inlet 118A disposed at a top end of the vapor side 118. In some embodiments, the hybrid system 100 is configured to pass the sweeping gas over the membrane 116 in the vapor side 118 of the SGMD unit 102 to produce a humidified gas 125 and exit the humidified gas 125 from a gas outlet 118B disposed at a bottom end of the vapor side 118. In some embodiments, the flow of the feed stream 110 in the liquid side 114 and the vapor side 118 of the SGMD unit 102 may be vertical, horizontal, or inclined, without any limitations. In some embodiments, the SGMD unit 102 may be any one of a spiral wound configuration, a tubular membrane configuration, a hollow fiber membrane configuration, or a flat sheet (plate and frame) membrane configuration, without any limitations.

As illustrated in FIG. 1A, the bubble dehumidifier unit 104 includes a gas inlet 130A connected to the gas outlet 118B of the vapor side 118 of the SGMD unit 102. In some embodiments, the gas inlet 130A is disposed at a bottom end of the bubble dehumidifier unit 104. However, in some embodiments, the gas inlet 130A may be disposed at a side, or a top of the bubble dehumidifier unit 104, as per requirements of a particular site of employment, other components, the exact configuration, or other concern or constraint of the hybrid system 100. The bubble dehumidifier unit 104 further includes a gas outlet 130B disposed at a top end of the bubble dehumidifier unit 104. The gas outlet 130B is configured to transfer a dehumidified gas 131, out of the bubble dehumidifier unit 104, for further processing or use. In some embodiments, the bubble dehumidifier unit 104 includes a freshwater inlet 134A and a freshwater outlet 134B. In an embodiment, the freshwater inlet 134A is defined at the bottom end of the bubble dehumidifier unit 104. In some embodiments, the freshwater inlet 134A may be defined at a side or the top end of the bubble dehumidifier unit 104 as per requirements of a particular site of employment, other components, the exact configuration, or other concern or constraint of the hybrid system 100. The bubble dehumidifier unit 104 is configured to pass the humidified gas 125 through a freshwater in the form of bubbles 138, thereby producing the dehumidified gas 131. To accomplish this, in some embodiments, the bubble dehumidifier unit 104 defines a volume configured to store a pre-determined amount of freshwater (which may be cooled as described herein) in order to bring down an elevated temperature of the humidified gas 125 received from the SGMD unit 102. The humidified gas 125 is configured to enter the bubble dehumidifier unit 104 through the gas inlet 130A. The gas inlet 130A is configured to fluidly couple to the volume containing the freshwater in the bubble dehumidifier unit 104. In some embodiments, the cooled freshwater present in the bubble dehumidifier unit 104, cools the hot humidified gas 125, producing two outputs, a condensate of freshwater and the dehumidified gas 131. The dehumidified gas 131 is transferred out of the bubble dehumidifier unit 104 via the gas outlet 130B. In some embodiments, the dehumidification process conducted by the bubble dehumidifier unit 104 produces excess freshwater, which may be drained out and collected in a freshwater tank 140. In some embodiments, the freshwater tank 140 is disposed in a vicinity of the bottom end of the bubble dehumidifier unit 104. In some embodiments, the freshwater outlet 134B is fluidly coupled to an inlet 140A of the freshwater tank 140. In some embodiments, the freshwater tank 140 may be manufactured using stainless steel or a polymer, and a size of the freshwater tank 140 may depend on an approximate freshwater output produced by the hybrid system 100.

In some embodiments, the bubble dehumidifier unit 104 is configured to recirculate the water as contained in the volume of the bubble dehumidifier unit 104. In some embodiments, such recirculation is accomplished through a recirculation outlet 136B. In some embodiments, the water is recirculated to a recirculation cooler 135. The recirculation cooler 135 can be configured to cool the water of the bubble dehumidifier unit 104. In some embodiments, the recirculation cooler 135 cools the water to produce a cooled water and provide the cooled water to the freshwater contained in the bubble dehumidifier unit 104 via a recirculation inlet 136A. In general, the recirculation cooler 135 can be any suitable type of cooler, such as a thermoelectric cooler, a cooling tower, a heat exchanger, and the like. The recirculation cooler 135 may be advantageous to for maintaining a low temperature of the water. A low temperature of the water may be particularly advantageous for maintaining a high dehumidification efficiency of the bubble dehumidifier unit 104.

In some embodiments, a spray nozzle 142 is disposed at the top end of the bubble dehumidifier unit 104 and fluidly coupled to the recirculation inlet 136A. In some embodiments, the spray nozzle 142 receives the cooled water from the recirculation cooler 135. The spray nozzle 142 can be configured to spray the cooled water (for example, as received from the recirculation cooler 135) into the bubble dehumidifier unit 104. The spray can be configured to be produced such that the cooled water contacts the dehumidified gas 131. In some embodiments, the spray nozzle 142 is configured to produce a widespread spray of the cooled water in order to increase contact with the dehumidified gas. Such widespread contact may assist in further cooling the dehumidified gas 131 emerging from the bubble dehumidifier unit 104. This cooling via spray may be advantageous for achieving a further decrease in the temperature of the dehumidified gas 131, and consequently, achieving better cooling efficiency. In some embodiments, the spray nozzle 142 can be pressure operated, by an in-line pressure generated by the recirculation cooler 135. Such pressure operation may be advantageous for conserving energy in order to make the hybrid system 100 more efficient. In some embodiments, the spray nozzle 142 may be manufactured using corrosion resistant and high tensile strength metals such as, but are not limited to, brass, stainless steel, and metal alloys.

In some embodiments, the hybrid system 100 further includes a dehumidified air cooler 145 configured to cool the dehumidified gas 131 exiting the bubble dehumidifier unit 104, thereby producing a cooled gas. That is, the dehumidified air cooler 145 may be employed, to further enhance a cooling effect or a further lower a temperature of a cooled air generated by the hybrid system 100. In some embodiments, the dehumidified air cooler 145 includes an inlet 145A and an outlet 145B. In some embodiments, the inlet 145A is configured to be in fluid communication with the gas outlet 130B of the bubble dehumidifier unit 104, and the outlet 145B may be in fluid communication with a space 150 requiring air conditioning. In general, the space 150 may refer to any enclosed space that may be air conditioned. The space 150 may be a commercial or non-commercial property, such as a home, housing complex, apartment building, office building, mall, store, and the like. In an example, the dehumidified air cooler 145 may include more than one outlet having a plurality of conduits attached in order to deliver cooled gas to the space 150. In some embodiments, the dehumidified air cooler 145 includes an auxiliary freshwater tank 146, configured to collect freshwater produced by the cooling of the dehumidified gas 131. The dehumidified air cooler 145 may, by further cooling the dehumidified gas, produce a condensate, and thereby produce a gas which has both a lower temperature and a lower humidity than the dehumidified gas 131. That is, in certain embodiments, in addition to producing a lower temperature gas, the dehumidified air cooler 145 may produce additional freshwater. In some embodiments, the condensate is then collected and stored in the auxiliary freshwater tank 146. The use of both the bubble dehumidifier unit 104 and the dehumidified air cooler 145 may be advantageous for increasing an overall freshwater production and/or increasing the efficiency of the hybrid system 100. In some embodiments, for example as shown in FIG. 1A, the freshwater tank 140 and the auxiliary freshwater tank 146 may be fluidly coupled in order to supply the freshwater produced by the hybrid system 100 to the space 150.

Referring to FIG. 1B, a schematic diagram of an exemplary dehumidified air cooler 145 is illustrated, according to certain embodiments. In some embodiments, the dehumidified air cooler 145 is a thermoelectric cooler. In some embodiments, the dehumidified air cooler 145 includes a plurality of thermoelectric coolers (TECs) 160. In general, TECs make use of the Peltier effect to create a heat flux at the junction of two distinct types of materials. Typically, TECs are a solid-state active heat pump which transfers heat from one side of the TEC to the other, with consumption of electrical energy, depending on the direction of the current. In some embodiments, the use of TECs 160 in the dehumidified air cooler 145 may be advantageous for increasing an electrical efficiency by consuming a lower amount of energy compared to other types of coolers. Such energy may be produced by the photovoltaic electricity generating unit 105 as described above. The use of the photovoltaic electricity generating unit 105 to produce electricity from solar energy may be advantageous for allowing the TECs 160 to be operated independently of grid electricity. In some embodiments, in order to further enhance the cooling effect produced by the hybrid system 100, a chilled-water coil 170 may also be disposed in line with the plurality of TECs 160. In some embodiments, the chilled-water coil 170 includes an inlet 170A and an outlet 170B, where the inlet 170A receives chilled water from external sources, followed by circulation of the chilled water in the chilled-water coil 170 and subsequently exit from the outlet 170B. In some embodiments, a different cooling fluid instead of the chilled water may be used in the dehumidified air cooler 145. In some embodiments, a number of the plurality of TECs 160 are independently controlled and operated. This independent operation may be advantageous to provide flexible control over a cooling capacity of the hybrid system 100. In some embodiments, a number of operational TECs of the plurality of TECs 160 may be decided depending upon a temperature requirement of the area of employment of the hybrid system 100.

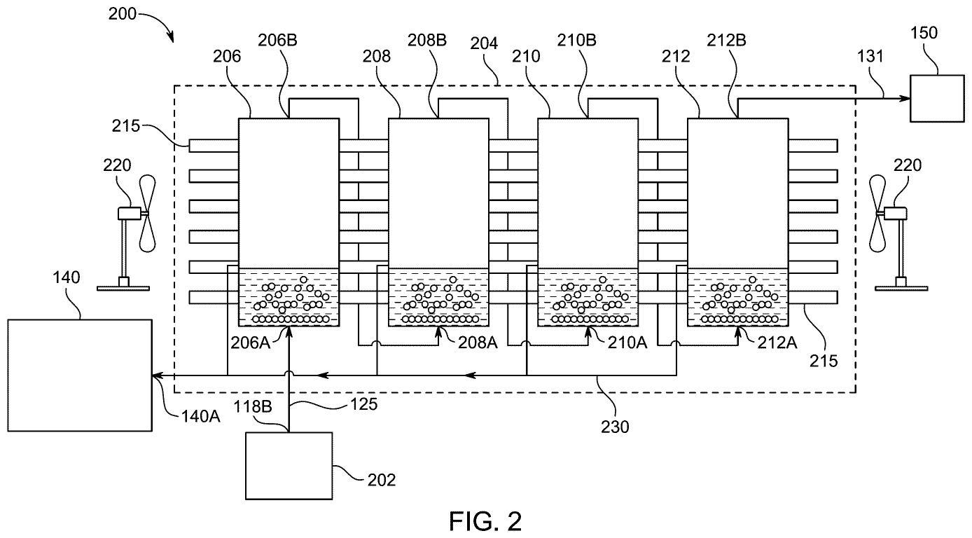

Referring to FIG. 2, illustrated is a schematic diagram of an exemplary hybrid system 200 having a multi-effect configuration, according to certain embodiments. In some embodiments, the hybrid system 200 may include some of the components in the hybrid system 100 as described above. In general, these components may interact or be configured in an equivalent manner across the SGMD unit 202 and the bubble dehumidifier unit 204, as described above. In general, the integration, configuration, and/or connectivity of the SGMD unit 202 and the bubble dehumidifier unit 204 in the hybrid system 200 may be similar to that of the hybrid system 100, together with any resulting benefits. For example, in some embodiments, in the hybrid system 200, the flow of the feed stream 110, the humidified gas 125, the dehumidified gas 131, and the recirculation of cooled water closely may resemble the flow in the hybrid system 100 as described above. However, as illustrated in FIG. 2, the hybrid system 200 introduces some distinct features in comparison to the hybrid system 100 as described below.

In some embodiments, the hybrid system 200 includes a plurality of bubble dehumidifier units 204. In some embodiments, the plurality of bubble dehumidifier units 204 are connected in a series configuration. In some embodiments, the plurality of bubble dehumidifier units 204 may include a first bubble dehumidifier unit 206, a second bubble dehumidifier unit 208, a third bubble dehumidifier unit 210, and a fourth bubble dehumidifier unit 212. In some embodiments, each of the plurality of bubble dehumidifier units 204 is configured to include a gas inlet and a gas outlet. In an example, the first bubble dehumidifier unit 206 includes a gas inlet 206A and a gas outlet 206B. The series configuration of the plurality of bubble dehumidifier units 204 may be achieved by connecting the gas inlet 206A of the first bubble dehumidifier unit 206 of the plurality of bubble dehumidifier units 204 to the gas outlet 118B of the vapor side 118 of the SGMD unit 202. The gas inlet of each other bubble dehumidifier unit of the plurality of bubble dehumidifier units 204 may then be connected to the gas outlet of a preceding bubble dehumidifier unit. As such, a gas inlet 208A of the second bubble dehumidifier unit 208 is configured to be in fluid communication with the gas outlet 206B of the first bubble dehumidifier unit 206. In a similar pattern, gas outlets of each of the plurality of bubble dehumidifier units 204 are intra-communicated with gas inlets of each of the plurality of bubble dehumidifier unit 204. For example, a gas inlet 210A of the third bubble dehumidifier unit 210 is coupled to a gas outlet 208B of the second bubble dehumidifier unit 208, a gas inlet 212A of the fourth bubble dehumidifier unit 212 is coupled to a gas outlet 210B of the third bubble dehumidifier unit 210, and lastly, a gas outlet 212B of the fourth bubble dehumidifier unit 212 is configured to supply the dehumidified gas 131 having low temperature to the space 150, requiring air conditioning.

In some embodiments, an external surface of one or more of the plurality of bubble dehumidifier units 204 may include cooling fins 215. The cooling fins 215 may be advantageous for facilitating efficient heat dissipation of the water present in the plurality of bubble dehumidifier units 204. In some embodiments, the cooling fins 215 increases a surface area of the external surface of the plurality of bubble dehumidifier units 204, in contact with the environment, to dissipate excess heat faster and more efficiently. In some embodiments, the cooling fins 215 are designed as horizontal slats. In some embodiments, the cooling fins 215 are designed as vertical slats. In some embodiments, the slats (whether vertical, horizontal, some other orientation, or a combination of these) are configured to be attached to the plurality of bubble dehumidifier units 204. In some embodiments, the cooling fins 215 are formed from a highly heat conductive metal, such as copper, aluminum, and the like. In some embodiments, the cooling fins 215 may be augmented, in heat dissipation, by forced air convection. In some embodiments, the forced air convection is achieved by employing one or more fans 220. In some embodiments, the one or more fans 220 are placed on either end (a left end and a right end) of the plurality of the bubble dehumidifier units 204. That is, a fan can be placed at a position such that it blows air across multiple bubble dehumidifier units 204 in a direction in which the bubble dehumidifier units 204 are arranged. For example, for a linear configuration, the fan can be placed to the left of a leftmost bubble dehumidifier unit 204. Such fan can be configured to blow air to the right such that an air current passes over the bubble dehumidifier units 204. Such a fan can be configured to blow to the right, creating an air current by a suction-like force that causes an air current to be pulled across the bubble dehumidifier units 204. It should be understood that the placement of the one or more fans 220 may change depending on the area of employment of the hybrid system 200. In some embodiments, the one or more fans 220 are aerodynamically designed to consume minimal power. In some embodiments, the one or more fans 220 may be powered by the photovoltaic electricity generating unit 105. This further use of generated electricity from solar energy may further enhance the efficiency of the hybrid system 200 and reduce dependency on non-renewable energy sources.

In some embodiments, the freshwater generated by the plurality of dehumidifier units 204 is collectively transferred to a conduit 230, fluidly connected to the inlet 140A of the freshwater tank 140, in order to collect the freshwater generated for further use.

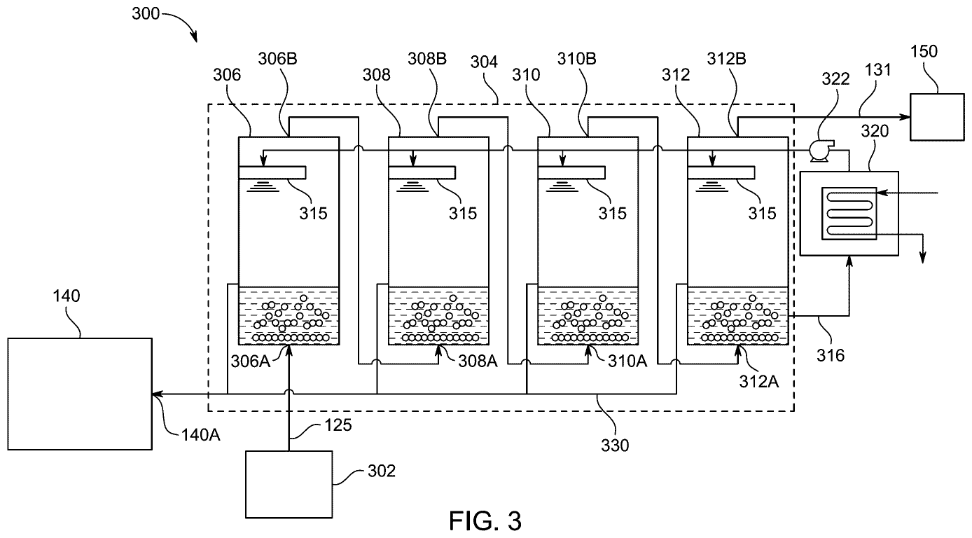

Referring to FIG. 3, illustrated is a schematic diagram of an exemplary hybrid system 300 having a multi-effect configuration, according to certain embodiments. In some embodiments, the hybrid system 300 may include some of the components in one or more of the hybrid systems 100 and/or 200, as described above. In general, these components may interact or be configured in an equivalent manner across the SGMD unit 302 and the bubble dehumidifier unit 304, as described above. In general, the integration, configuration, and/or connectivity of the SGMD unit 302 and the bubble dehumidifier unit 304 in the hybrid system 300 may be similar to that of one or more of the hybrid systems 100 and/or 200, as described above. For example, in some embodiments, in the hybrid system 300, the flow of the feed stream 110, the humidified gas 125, the dehumidified gas 131, and the recirculation of cooled water may resemble the flow in the hybrid system 100 and/or 200 as described above.

In some embodiments, the hybrid system 300 includes a plurality of bubble dehumidifier units 304 including a first bubble dehumidifier unit 306, a second bubble dehumidifier unit 308, a third bubble dehumidifier unit 310, and a fourth bubble dehumidifier unit 312. In general, each of the plurality of bubble dehumidifier units 304 can include a gas inlet and a gas outlet. That is, the first bubble dehumidifier unit 306 can include a gas inlet 306A and a gas outlet 306B, the second bubble dehumidifier unit 308 can include a gas inlet 308A and a gas outlet 308B, the third bubble dehumidifier unit 310 can include a gas inlet 310A and a gas outlet 310B, and the fourth bubble dehumidifier unit 312 can include a gas inlet 312A and a gas outlet 312B. In some embodiments, the gas inlet of a subsequent bubble dehumidifier unit is configured to fluidly couple with the gas outlet of a preceding bubble dehumidifier unit. As such, the gas inlet 308A of the second bubble dehumidifier unit 308 can be configured to fluidly couple with the gas outlet 306B of the first bubble dehumidifier unit 306. In some embodiments, each of the plurality of bubble dehumidifier units 304 are inter-connected in an equivalent manner as described above. In some embodiments, the gas outlet 312B of the fourth bubble dehumidifier unit 312 is configured to supply the dehumidified gas 131 (cooled) to the space 150. In some embodiments, each of the plurality of bubble dehumidifier units 304 includes a spray nozzle 315. Spraying water in each of the plurality of bubble dehumidifier units 304 may result in additional cooling and/or condensation for the gas present inside the plurality of bubble dehumidifier units 304. This additional cooling and/or condensation may be advantageous for increasing condensate water collection. In some embodiments, by implementing the hybrid system 300, a number of bubble column dehumidifier units required to deliver air to the required space may be reduced. This reduction in the number of bubble column dehumidifier units may achieve an equivalent metric of another hybrid system, such as a measure of an amount of freshwater generated per unit time, an amount of freshwater generated per unit energy consumed, a cooled air temperature difference from ambient temperature per unit energy consumed, a volume of cooled air delivered per unit energy consumed, a volume of cooled air delivered per unit time, etc.

In some embodiments, the spray nozzle 315 is disposed at the top of each of the plurality of bubble dehumidifier units 304 in order to spray cooled water into the plurality of bubble dehumidifier units 304. Preferably, this cooled water is freshwater. In some embodiments, an amount of water is extracted from the fourth bubble dehumidifier unit 312 and re-circulated through a recirculation line 316 to spray from top of each of the plurality of bubble dehumidifier units 304 via the spray nozzle 315. In general, the fourth bubble dehumidifier unit 312 may have the water at lowest temperature, since the water has already been cooled off and processed through preceding bubble dehumidifier units including the first bubble dehumidifier unit 306, the second bubble dehumidifier unit 308, and the third bubble dehumidifier unit 310. In some embodiments, a temperature of the circulated water from the fourth bubble dehumidifier unit 312 is controlled through a recirculation cooler 320. That is, the portion of water taken from the fourth bubble dehumidifier unit to be re-circulated for spraying via the spray nozzle is cooled by the recirculation cooler prior to spraying. In some embodiments, the re-circulated water is at a lower temperature compared to the water present in the plurality of the bubble dehumidifier units 304, and also lower than the air leaving each of the plurality of bubble dehumidifier units 304. In some embodiments, the recirculated water is sprayed from the top of each of the plurality of dehumidifier unit 304 in order to cool the dehumidified gas 131 leaving from each of the plurality of bubble dehumidifier units 304. In some embodiments, an amount of cold water sprayed in each of the plurality of bubble dehumidifier units 304 may be controlled based on the required conditions in each of the plurality of bubble dehumidifier units 304, such as a volume of gas passing through the bubble dehumidifier unit, a temperature of the gas passing through the bubble dehumidifier unit, a temperature of the water in the bubble dehumidifier unit, etc. In some embodiments, the amount of cold water sprayed may be controlled by employing external control valves (not shown) corresponding to each spray nozzle 315. In some embodiments, a fluid pump 322 may be used to pressurize the water sprayed from the spray nozzle 315. In some embodiments, for precise volume control, an individual pressure pump (not shown) may be used with each spray nozzle 315.

In general, the spray nozzle 315 may be formed of any suitable material. In some embodiments, the spray nozzle 315 is formed of a corrosion resistance metal. In general, the spray nozzle 315 may take any suitable form and have any suitable design features to achieve the spraying described herein. For example, the spray nozzle 315 may include a perforated plate or a shower head design.

In some embodiments, the freshwater generated by the plurality of dehumidifier units 304 is collectively transferred to a conduit 330, fluidly connected to the inlet 140A of the freshwater tank 140, in order to collect the freshwater generated for further use.

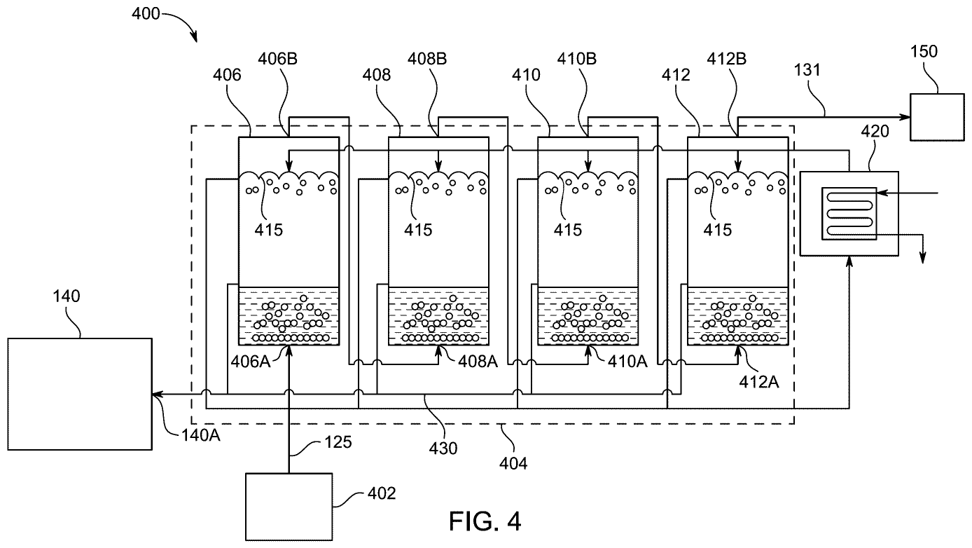

Referring to FIG. 4, illustrated is a schematic diagram of an exemplary hybrid system 400 having a multi-effect configuration, according to certain embodiments. In some embodiments, the hybrid system 400 may include some of the components in one or more of the hybrid systems 100, 200, and/or 300 as described above. In general, these components may interact or be configured in an equivalent manner across the SGMD unit 402 and the bubble dehumidifier unit 404, as described above. In general, the integration, configuration, and/or connectivity of the SGMD unit 402 and the bubble dehumidifier unit 404 in the hybrid system 400 may be similar to that of one or more of the hybrid systems 100, 200 and/or 300, as described above. For example, in some embodiments, in the hybrid system 400, the flow of the feed stream 110, the humidified gas 125, the dehumidified gas 131, and the recirculation of cooled water may resemble the flow in any of the hybrid systems 100, 200, and/or 300. In some embodiments, the hybrid system 400 includes a plurality of bubble dehumidifier units 404 including a first bubble dehumidifier unit 406, a second bubble dehumidifier unit 408, a third bubble dehumidifier unit 410, and a fourth bubble dehumidifier unit 412. In general, the plurality of bubble dehumidifier units 404 may be similar to that of the hybrid system 300, as described above. In some embodiments, each of the plurality of bubble dehumidifier units 404 includes a gas inlet and a gas outlet. That is, the first bubble dehumidifier unit 406 can include a gas inlet 406A and a gas outlet 406B, the second bubble dehumidifier unit 408 can include a gas inlet 408A and a gas outlet 408B, the third bubble dehumidifier unit 410 can include a gas inlet 410A and a gas outlet 410B, and the fourth bubble dehumidifier unit 412 can include a gas inlet 412A and a gas outlet 412B. In some embodiments, the gas inlet of a subsequent bubble dehumidifier unit is configured to fluidly couple with the gas outlet of a preceding bubble dehumidifier unit. For example, the gas inlet 408A of the second bubble dehumidifier unit 408 can be configured to fluidly couple with the gas outlet 406B of the first bubble dehumidifier unit 406. In some embodiments, each of the plurality of bubble dehumidifier units 404 are inter-connected in a similar manner as described above. In some embodiments, the gas outlet 412B of the fourth bubble dehumidifier unit 412 is configured to supply the dehumidified gas 131 (cooled) to the space 150.

In some embodiments, the hybrid system 400, the plurality of bubble dehumidifier units 404 includes a vapor trap 415 disposed at a top of the bubble dehumidifier unit 404. In some embodiments, each of the plurality of bubble dehumidifier units 404 includes the vapor trap 415. In some embodiments, the vapor trap 415 is configured to be cooled to a temperature below a temperature of the dehumidified gas 131 emerging from the plurality of bubble dehumidifier units 404. The vapor trap 415 may be employed to further reduce the temperature of the dehumidified gas 131. In some embodiments, the vapor trap 415 can be cooled via cooled water produced from one or more of the bubble dehumidifier units. For example, cooled water can be extracted from the fourth bubble dehumidifier unit 412 then circulated through one or more of the vapor traps. In some embodiments, the cooled water extracted from one or more of the bubble dehumidifier units can be cooled to a desired temperature through the use of a recirculation cooler 420. In such embodiments, after processing in the recirculation cooler 420, cooled water can be transferred to the vapor trap 415 configured to be disposed at the top of each of the plurality of bubble dehumidifier units 404.

The use of the vapor trap 415 may be advantageous for including in the hybrid system 400. For example, the vapor trap 415 can provide additional cooling for the dehumidified gas 131 before it exits the plurality of bubble dehumidifier units 404. Such extra cooling may further provide additional cooling to the space to which the gas is delivered and/or may increase the amount of freshwater generated in the bubble dehumidifier units. For example, the vapor trap 415 can be configured to trap water vapor still present in the dehumidified gas 131, as generated by the plurality of bubble dehumidifier units 404. As the dehumidified gas 131 passes over the cold surface of the vapor trap 415, the water content present in the dehumidified gas 131 condenses on a surface of the vapor trap 415, effectively removing the water content in form of condensate, from the dehumidified gas 131. This condensed water can be collected as additional distilled water, resulting from the vapor trap 415. The extra condensate generated by the vapor trap 415 is typically at a low temperature, which may result from contact with the vapor trap. In some examples, the extra condensate may be routed to the plurality of bubble dehumidifier units 404. This may be advantageous for maintaining a low temperature of the water present in the plurality of bubble dehumidifier units 404.

In some embodiments, a size of the vapor trap 415 is decided based on an output generated by the hybrid system 400. In general, the vapor trap 415 can be formed of any suitable material. In some embodiments, the vapor trap 415 is formed of highly heat conductive materials, such as copper or aluminum. A high heat exchange coefficient resulting from highly conductive materials may be advantageous for increasing an efficiency of the vapor trap 415.

In some embodiments, the freshwater generated by the plurality of dehumidifier units 404 is collectively transferred to a conduit 430, fluidly connected to the inlet 140A of the freshwater tank 140, in order to collect the freshwater generated for further use.

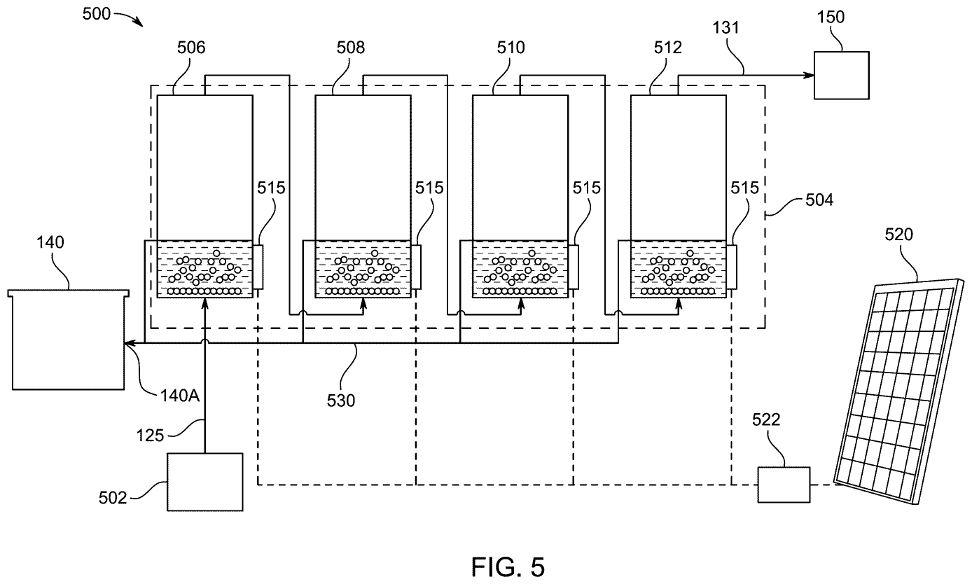

Referring to FIG. 5, illustrated is a schematic diagram of an exemplary hybrid system 500 having a multi-effect configuration, according to certain embodiments. In some embodiments, the hybrid system 500 may include some of the components in one or more of the hybrid systems 100, 200, 300, and/or 400 as described above. In general, these components may interact or be configured in an equivalent manner across the SGMD unit 502 and the bubble dehumidifier unit 504, as described above. In general, the integration, configuration, and/or connectivity of the SGMD unit 502 and the bubble dehumidifier unit 504 in the hybrid system 500 may be similar to that of one or more of the hybrid systems 100, 200, 300, and/or 400, as described above. For example, in some embodiments, in the hybrid system 500, the flow of the feed stream 110, the humidified gas 125, the dehumidified gas 131, and the recirculation of cooled water may resemble the flow in the hybrid systems 300, 400. In some embodiments, the hybrid system 500 includes a plurality of bubble dehumidifier units 504 including a first bubble dehumidifier unit 506, a second bubble dehumidifier unit 508, a third bubble dehumidifier unit 510, and a fourth bubble dehumidifier unit 512, similar to that of the hybrid systems 300, 400.

In some embodiments, each of the plurality of bubble dehumidifier units 504 in the hybrid system 500 includes a thermoelectric cooler 515. In some embodiments, each of the plurality of bubble dehumidifier units 504 is configured to be in thermal communication with a corresponding thermoelectric cooler 515. In some embodiments, the thermoelectric cooler 515 is disposed at a side of each of the plurality of bubble dehumidifier units 504. In some embodiments, a position of the thermoelectric cooler 515 may change depending upon space available at a particular site of employment of the hybrid system 500. As explained above, thermoelectric coolers are highly efficient and consume low energy to provide cooling effect. The inclusion of the thermoelectric cooler 515 may be advantageous for allowing the plurality of bubble dehumidifier units 504 to dissipate excess heat more effectively and/or maintain a low temperature for the plurality of bubble dehumidifier units 504 or the water contained therein. This low temperature may be advantageous for increasing the efficiency of the plurality of bubble dehumidifier units 504 or may extend an operational length of the hybrid system 500. In some embodiments, the hybrid system 500 may include a dedicated photovoltaic electricity generating unit 520. In such embodiments, the photovoltaic electricity generating unit 520 can be configured to generate electricity to supply the thermoelectric cooler 515 with renewable energy. The photovoltaic electricity generating unit 520 may be advantageous for increasing an energy efficiency or decreasing an environmental impact of the hybrid system 500. In some embodiments, a control unit 522 is configured to be electrically communicated with the hybrid system 500 and the photovoltaic electricity generating unit 520. In some embodiments, the control unit 522 provides control over the power supply being transmitted to the hybrid system 500 from the photovoltaic electricity generating unit 520. In some embodiments, the control unit 522 is programmed to provide intervention for adjusting a number of operational thermoelectric coolers 515. For example, if load on the hybrid system 500 is low (lower cooling and/or freshwater generation requirement) then the control unit 522 may be used to disable a certain number of the thermoelectric coolers 515, for example by hindering, lowering, or stopping the power supply to a particular thermoelectric cooler 515. The operation of the control unit 522 may be automatic. That is, the control unit 522 can be programmed to perform the various functions related to controlling the operation of the hybrid system 500 without direct or continuous user input. Such automatic operation can include collection and/or processing of data from various sensors that can be included in the hybrid system 500. Examples of such sensors include, but are not limited to temperature sensors, flowrate sensors, pressure sensors, valve state sensors, and the like.

In some embodiments, the freshwater generated by the plurality of dehumidifier units 504 is collectively transferred to a conduit 530, fluidly connected to the inlet 140A of the freshwater tank 140, in order to collect the freshwater generated for further use.

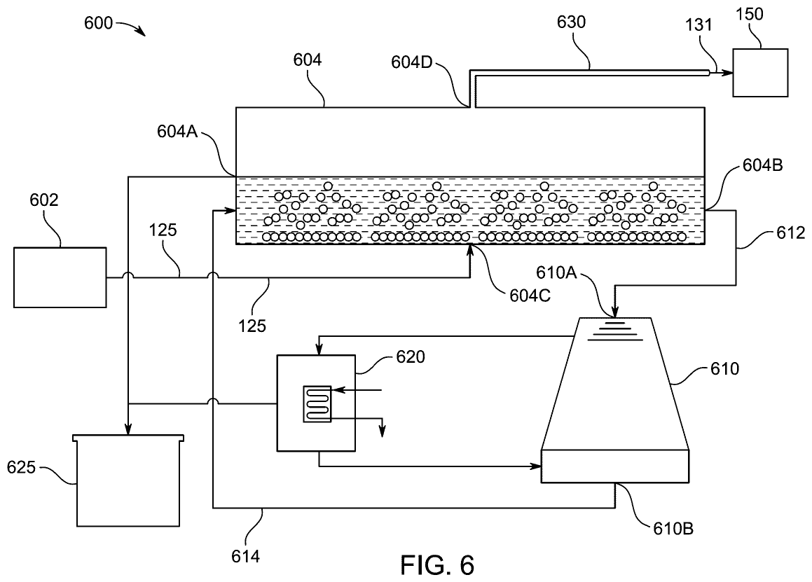

Referring to FIG. 6, illustrated is a schematic diagram of an exemplary hybrid system 600 having a multi-effect configuration, according to certain embodiments. In some embodiments, the hybrid system 600 may include some of the components in one or more of the hybrid systems 100, 200, 300, 400, and/or 500 as described above. In general, these components may interact or be configured in an equivalent manner across the SGMD unit 602 and the bubble dehumidifier unit 604, as described above. In general, the integration, configuration, and/or connectivity of the SGMD unit 602 and the bubble dehumidifier unit 604 in the hybrid system 600 may be similar to that of one or more of the hybrid systems 100, 200, 300, 400, and/or 500 as described above. For example, in some embodiments, in the hybrid system 600, the flow of the feed stream 110, the humidified gas 125, the dehumidified gas 131, and the recirculation of cooled water may resemble the flow in the hybrid system 100.

In some embodiments, the hybrid system 600 includes a cooling tower 610. In some embodiments, the water from the bubble dehumidifier unit 604 can be circulated through the cooling tower 610. In some embodiments, the cooling tower 610 has an inlet 610A, disposed at a top of the cooling tower 610 and an outlet 610B disposed at a bottom of the cooling tower 610. In some embodiments, the inlet 610A is configured to be in fluid communication with a liquid outlet 604B of the bubble dehumidifier unit 604 via an outlet conduit 612. In some embodiments, the outlet 610B of the cooling tower 610 is in fluid communication with a liquid inlet 604A of the bubble dehumidifier unit 604 via an inlet conduit 614. For example, the cooling tower 610 and the bubble dehumidifier unit 604 can form a closed-loop for fluid circulation. In general, the cooling tower can be any suitable shape. The shape of the cooling tower may depend on or be adapted to the area of employment of the hybrid system 600. In some embodiments, the cooling tower 610 has a narrow top and a wide bottom in order to facilitate better cooling, for example by rising air currents.

In general, the cooling tower 610 can be formed of any suitable material. In some embodiments, the cooling tower 610 is constructed using corrosion resistant metal and metal alloys. In some embodiments, cooling in the hybrid system 600 can be accomplished by circulating the water present in the bubble dehumidifier unit 604 to the cooling tower 610. For example, the water can be received from the inlet 610A of the cooling tower 610 and sprayed down (from the top of the cooling tower 610 to the bottom) inside the cooling tower 610 to cool the water to a lower temperature. This process can generate cooled water which is transferred to the inlet 604A of the bubble dehumidifier unit 604 via the outlet 610B of the cooling tower 610. In some embodiments, the cooling tower 610 generates humid air inside the cooling tower 610 which may be condensed using an external heat exchanger 620.

In some embodiments, a freshwater collection tank 625 can be included and configured to interface with the hybrid system 600. The freshwater collection tank 625 can receive condensate from the bubble dehumidifier unit 604. In some embodiments, the hybrid system 600 can include an external heat exchanger 620. The inclusion of the external heat exchanger 620 can be advantageous for providing increasing an amount of freshwater generated by the system and/or improving the efficiency of the hybrid system 600 as measured by, for example an amount of freshwater generated per unit time, an amount of freshwater generated per unit energy consumed, a cooled air temperature difference from ambient temperature per unit energy consumed, a volume of cooled air delivered per unit energy consumed, a volume of cooled air delivered per unit time, etc. In some embodiments, the cooled dehumidified gas 131 from the bubble dehumidifier unit 604 is sent to the space 150 requiring air conditioning via a conduit 630. In some embodiments, the conduit 630 can be thermally insulated.

In some embodiments, the bubble dehumidifier unit 604 includes a gas inlet 604C and a gas outlet 604D, where the gas inlet 604C is configured to receive the humidified gas 125 from the SGMD unit 602 and the gas outlet 604D is configured to transfer the dehumidified gas 131 out of the bubble dehumidifier unit 604.

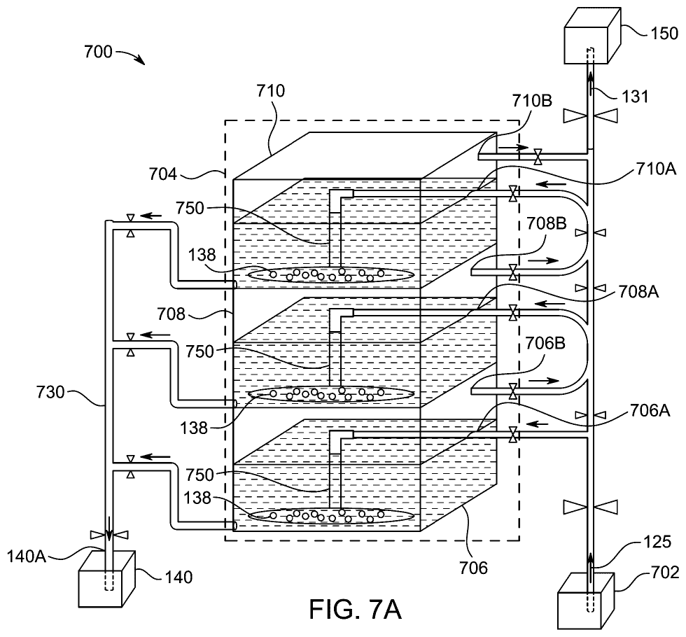

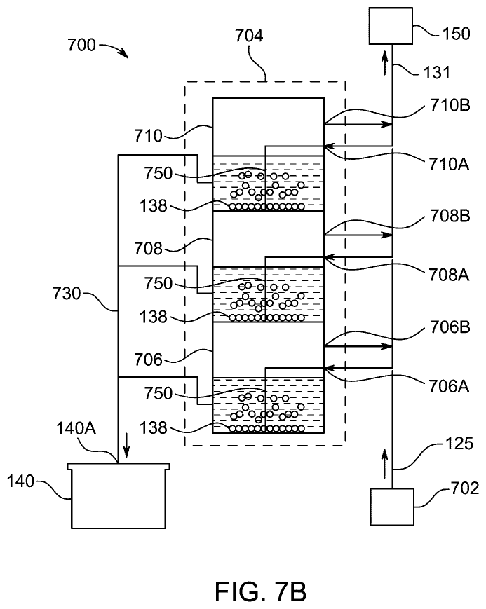

Referring to FIG. 7A and FIG. 7B, illustrated is a schematic diagram of an exemplary hybrid system 700 having a multi-effect configuration, according to certain embodiments. In some embodiments, the hybrid system 700 may include some of the components in one or more of the hybrid systems 100, 200, 300, 400,500, and/or 600, as described above. In general, these components may interact or be configured in an equivalent manner across the SGMD unit 702 and the plurality of bubble dehumidifier units 704, as described above. In general, the integration, configuration, and/or connectivity of the SGMD unit 702 and the plurality of bubble dehumidifier units 704 in the hybrid system 700 may be similar to that of one or more of the hybrid systems 100, 200, 300, 400, 500, and/or 600 as described above. For example, in some embodiments, in the hybrid system 700, the flow of the feed stream 110, the humidified gas 125, the dehumidified gas 131, and the recirculation of cooled water may resemble the flow in the hybrid system 100, 200, 300, 400, 500 and/or 600.

In some embodiments, the plurality of bubble dehumidifier units 704 further includes a first bubble dehumidifier unit 706, a second bubble dehumidifier unit 708, and a third bubble dehumidifier unit 710. In some embodiments, each of the plurality of bubble dehumidifier units 704 includes a gas inlet and a gas outlet. For example, the first bubble dehumidifier unit 706 can include a gas inlet 706A and a gas outlet 706B, the second bubble dehumidifier unit 708 can include a gas inlet 708A and a gas outlet 708B, and the third bubble dehumidifier unit 710 can include a gas inlet 710A and a gas outlet 710B. In some embodiments, the gas inlet 706A is connected to the gas outlet of the SGMD unit 702. In some embodiments, the gas inlet 706A of the first bubble dehumidifier unit 706 of the plurality of bubble dehumidifier units 704 is configured to receive the humidified gas 125 from the SGMD unit 702. In some embodiments, the gas outlets 706B, 708B, and 710B are disposed at a side of each of the plurality of bubble dehumidifier units 704, as such, the gas outlets are configured to transfer the dehumidified gas 131 from the plurality of bubble dehumidifier units 704, to a dehumidified air cooler. In some embodiments, the dehumidified air cooler is configured to cool the dehumidified gas 131 exiting the third bubble dehumidifier unit 710, thereby producing a cooled gas. This cooled gas may be transferred to the space 150 requiring air-conditioning.

In some embodiments, each bubble dehumidifier is connected in parallel. That is, the bubble dehumidifier outputs the dehumidified gas directly to the dehumidified air cooler. In some embodiments, each of the plurality of bubble dehumidifier units 704 are connected in series configuration, as such, the gas inlet 706A of the first bubble dehumidifier unit 706 is connected to the gas outlet of the SGMD unit 702 and the gas inlets 708A, 710A are connected to the gas outlets 706B, 708B of the preceding bubble dehumidifier unit of the plurality of bubble dehumidifier units 704.

In some embodiments, each of the plurality of bubble dehumidifier units 704 is configured to pass the humidified gas 125 (as received from the SGMD unit 702) through freshwater in the form of bubbles 138, thereby producing the dehumidified gas 131. In some embodiments, each bubble dehumidifier unit of the plurality of bubble dehumidifier units 704 contains a different amount of freshwater. For example, the amount of freshwater in a given bubble dehumidifier unit may be greater than a subsequent bubble dehumidifier unit in series and less than a preceding bubble dehumidifier unit in series. That is, a volume of the freshwater present in the first bubble dehumidifier unit 706 is greater than the volume of freshwater present in the second bubble dehumidifier unit 708. In some embodiments, the freshwater level in each of the plurality of bubble dehumidifier units 704 is controlled by controlling the volume of freshwater removed of each of the plurality of bubble dehumidifier units 704. The removal of freshwater may be balanced by the amount of freshwater being generated in the bubble dehumidifier unit. For example, a freshwater level can be maintained when the freshwater removal rate is equal to the freshwater generation rate. In some embodiments, the freshwater extraction may be controlled by individual angle valve disposed with a common conduit 730. In some embodiments, the freshwater removal rate can be controlled by a controller, for example, by operation of the angle valve, as described above and below.

In some embodiments, the humidified gas 125 from the SGMD unit 702 is injected from the gas inlet 706A of the first bubble dehumidifier unit via a submerged tube 750. The use of the submerged tube 750 may be advantageous for reducing an overall size of the hybrid system 700 by reducing an amount of external tubing required for the hybrid system. In some embodiments, the gas inlet of a bubble dehumidifier unit (e.g., 706A) enters the bubble dehumidifier unit (706) at an upper portion of a side of the bubble dehumidifier unit, or more preferably enters the bubble dehumidifier unit from a top. The gas inlet then extends from an upper portion of the side or the top of the bubble dehumidifier unit to a bottom of the bubble dehumidifier unit. Preferably the gas inlet descends from a centerpoint of the top of the bubble dehumidifier unit to a centerpoint of the bottom of the bubble dehumidifier unit. The gas inlet is preferably connected to a gas dispersion device, preferably in the form of a tubular circular or cylindrical device that is in direct and continuous contact with the bottom of the bubble dehumidifier unit. The form of the circular gas dispersion device is preferably in the form of a circle laying flat on the bottom of the bubble dehumidifier unit and connected at one or more points to the gas inlet. Preferably the cylindrical or circular gas dispersion device, in the form of a circle, has a series of evenly spaced apertures oriented towards the centerpoint of the bottom of the bubble dehumidifier unit all disposed opposite one another on a common inwardly facing surface of the gas dispersion device. In this orientation the gas dispersion device permits entry of humidified air into the freshwater of the bubble dehumidifier unit to form cylindrical curtain-like rising flow of gas bubbles. Preferably, the rising flow of gas bubbles meet the downward flow of freshwater from the freshwater inlet in the form of a descending cone of liquid droplets at a point such that the diameter of the cone is substantially the same as the diameter of the rising column of gas bubbles.

In some embodiments, the hybrid system 700 may also include the auxiliary components, such as a recirculation cooler, a spray nozzles, vapor traps and others, as included in the hybrid systems described above. Such auxiliary components can have a configuration, and/or connectivity similar to one or more of the hybrid systems described above.

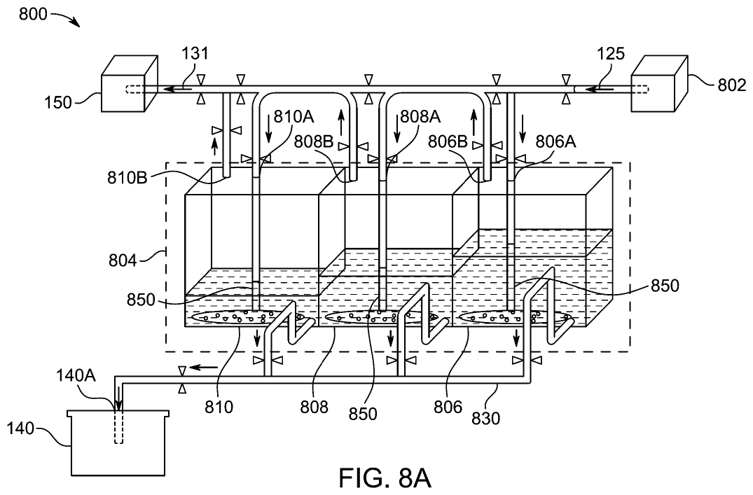

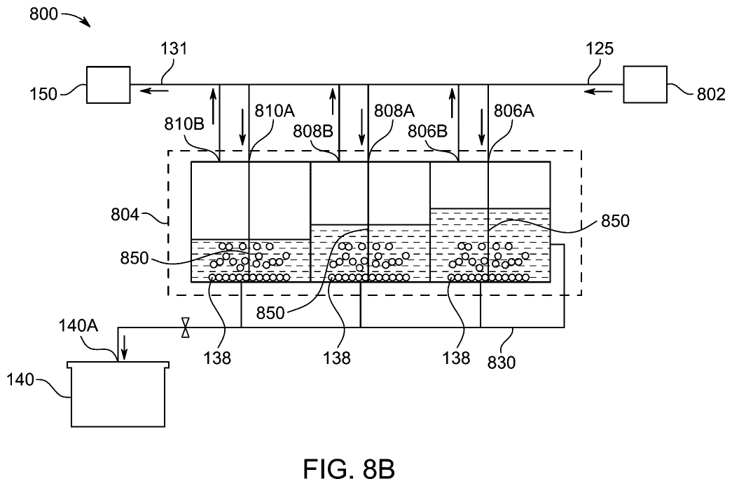

Referring to FIG. 8A and FIG. 8B, illustrated is a schematic perspective diagram of an exemplary hybrid system 800. In some embodiments, the hybrid system 800 may include some of the components in one or more of the hybrid systems 100, 200, 300, 400, 500, 600, and/or 700, as described above. In general, the integration, configuration, and/or connectivity of the SGMD unit 802 and the plurality of bubble dehumidifier units 804, may be similar to that of one or more of the hybrid systems 100, 200, 300, 400, 500, 600 and/or 700 as described above.

In some embodiments, the hybrid system 800 has a horizontal configuration of the hybrid system 800. This may be contrasted with the vertical configuration of the hybrid system 700. In some embodiments, the hybrid system 800 includes a SGMD unit 802 and a plurality of bubble dehumidifier units 804 arranged horizontally. The horizontal arrangement may be series arrangement or a parallel arrangement as described above. In general, the connections and flow of water and gases throughout the hybrid system 800 may be similar to that of the hybrid system 700, as described above. In some embodiments, the plurality of bubble dehumidifier units 804 of the hybrid system 800 include a first bubble dehumidifier unit 806, a second bubble dehumidifier unit 808, and a third bubble dehumidifier unit 810. In some embodiments, each of the plurality of bubble dehumidifier units 804 includes a gas inlet and a gas outlet. In some embodiments, the first bubble dehumidifier unit 806 can include a gas inlet 806A and a gas outlet 806B, the second bubble dehumidifier unit 808 can include a gas inlet 808A and a gas outlet 808B, and the third bubble dehumidifier unit 810 can include a gas inlet 810A and a gas outlet 810B. In some embodiments, the gas inlet of a subsequent bubble dehumidifier unit is configured to fluidly couple with the gas outlet of a preceding bubble dehumidifier unit. For example, the gas inlet 808A of the second bubble dehumidifier unit 808 can be configured to fluidly couple with the gas outlet 806B of the first bubble dehumidifier unit 806. In some embodiments, each of the plurality of bubble dehumidifier units 804 are inter-connected in a similar manner as described above. For example, the gas outlet 810B of the third bubble dehumidifier unit 810 can be configured to supply the dehumidified gas 131 (cooled) to the space 150. In some embodiments, the humidified gas 125 from the SGMD unit 802 is injected from the gas inlet 806A of the first bubble dehumidifier unit via a submerged tube 850. The use of the submerged tube 850 may be advantageous for reducing an overall size of the hybrid system 800 by reducing an amount of external tubing required for the hybrid system. In some embodiments, the freshwater extraction may be controlled by individual angle valve disposed with a common conduit 830. In some embodiments, the freshwater removal rate can be controlled by a controller, for example, by operation of the angle valve, as described above and below.

Referring to FIG. 8B, a schematic diagram of the hybrid system 800 is illustrated, according to certain embodiments. In particular, FIG. 8B depicts a two-dimensional view of the hybrid system 800 In some embodiments, the hybrid system 800 may also include the auxiliary components, such as a recirculation cooler, a spray nozzles, vapor traps and others, as included in the hybrid systems described above. Such auxiliary components can have a configuration, and/or connectivity similar to one or more of the hybrid systems described above.

The vertical hybrid system 700 and the horizontal hybrid system 800 may be associated with possess some distinct advantages compared to other systems. Such advantages may include maximum performance extraction from the bubble dehumidifier units 704, 804, as the humidified gas 125 is forced to move through each bubble dehumidifier unit of the plurality of bubble dehumidifier units 704, 804, which maximizes the air-water surface interface for efficient heat and mass transfer. This design may enhance the compactness of the hybrid systems 700, 800 while maintaining high effectiveness, low external or additional cooling requirements, and low fabrication costs when compared to conventional condensers and packed beds dehumidifiers. In addition, the hybrid system 700, 800 may be efficiently controlled in terms of the operation of any individual bubble dehumidifier unit (e.g., turning off or bypassing an individual bubble dehumidifier unit) while ensuring continuous operation of all other bubble dehumidifier units. This may be advantageous for conducting maintenance on any an individual bubble dehumidifier unit. Maintenance can be performed on the individual bubble dehumidifier unit without halting the entire system. That individual bubble dehumidifier unit can simply be turned off and/or bypassed for the duration of the maintenance. Similarly, if there is no need to operate all the plurality of bubble dehumidifier units 704, 804 due to low system requirements (e.g., low water demand or low cool air demand). This flexibility in individual control of each of the plurality of bubble dehumidifier units 704, 804 may be advantageous for providing continuous system operation and reducing system downtime during maintenance. Another advantage of the hybrid systems 700, 800 may be the exhibition of automated product/freshwater collection from each stage. The systems described above may permit continuous freshwater collection without a requirement of manual intervention in order to collect the generated freshwater from each of the plurality of bubble dehumidifier units 704, 804. Further, the use of a vertical (hybrid system 700) or horizontal (hybrid system 800) may be advantageous for reducing an overall footprint or space requirement of the system. A more compact system can be deployed in a wider range of contexts, situations, and locations. For example, depending upon a space allowance and requirement of a particular site of employment a vertical (hybrid system 700) or horizontal (hybrid system 800) may be more advantageous.

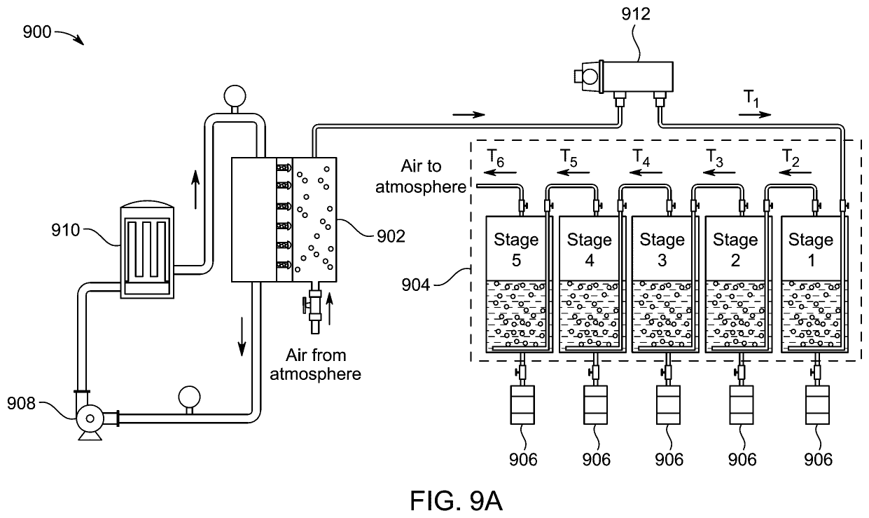

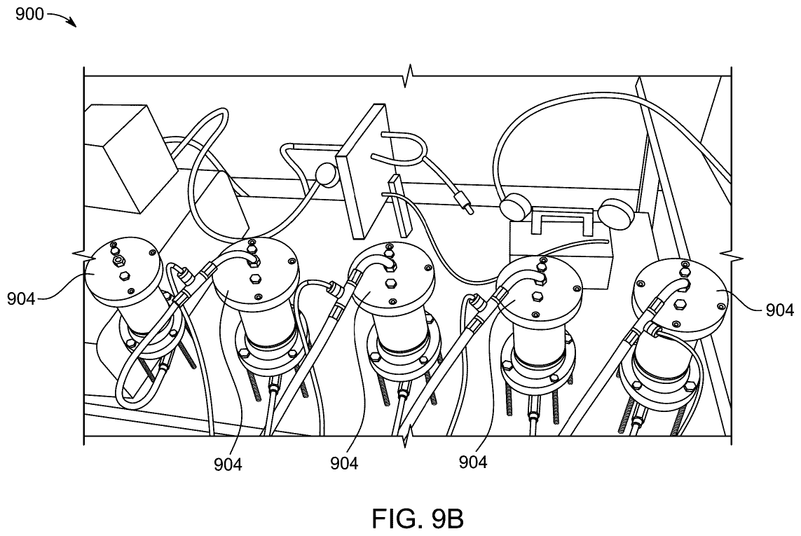

Referring to FIG. 9A, a schematic diagram of an experimental setup of an exemplary hybrid system 900 is illustrated, according to certain embodiments. FIG. 9B illustrates a partial perspective view of the exemplary hybrid system 900 of FIG. 9A, according to certain embodiments. The depicted exemplary hybrid system 900 includes a SGMD unit 902 and a plurality of bubble dehumidifier units 904, configured to be connected in series configuration, horizontally. In particular, the depicted exemplary hybrid system 900 includes five bubble dehumidifier units 904. Each of the five bubble dehumidifier units 904 includes a corresponding individual freshwater collection tank 906. The depicted exemplary hybrid system 900 further includes a water circulation pump 908 configured to circulate feed water between a liquid side of the SGMD unit 902 and a water heater 910. A vacuum pump 912 is disposed between the SGMD unit 902 and a first bubble dehumidifier unit of the plurality of bubble dehumidifier units 904 to supply humidified gas at a desired flow rate. A performance of the exemplary plurality of bubble dehumidifier units 904 was evaluated without applying any external cooling. The surroundings of the hybrid system 900 had a temperature of about 22 degrees Celsius (°C) and heat was dissipated naturally from the five bubble dehumidifier units 904 to the surrounding air. Other test conditions were as follow: feed temperature=70° C., feed flow rate =2.3 liters per minute (L/min) and air flow rate =1 CFM. The feed was a saltwater feed. A drop of 3° C. to 5° C. in the air temperature was be achieved after each bubble dehumidifier unit of the plurality of bubble dehumidifier units 904, without recirculation cooling. In addition, a temperature drop of about 5° C. to 7° C. was seen, after each bubble dehumidifier unit 904, when an air cooled hybrid system was used, similar to the exemplary hybrid system 200 depicted in FIG. 2 and described above. Using chilled water for cooling the plurality of bubble dehumidifier units 904 may keep the water and air temperatures at the minimum levels.

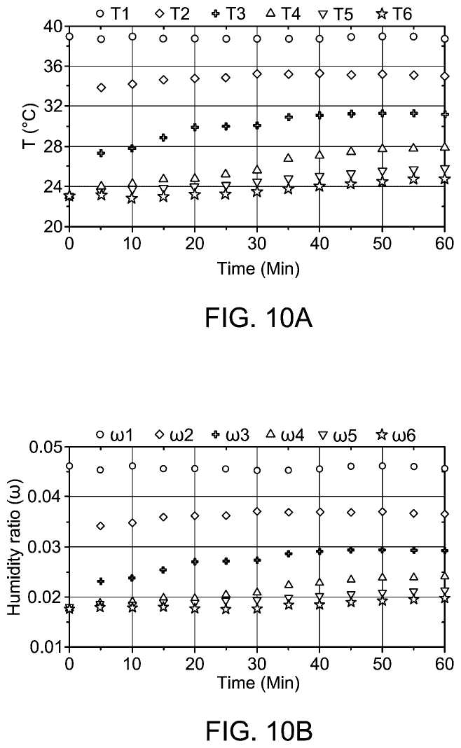

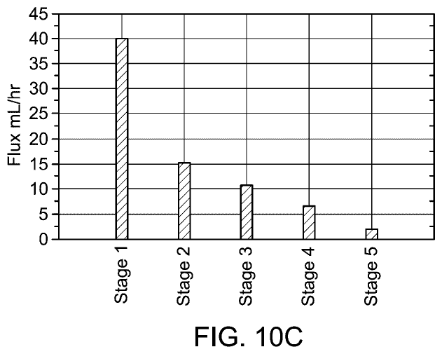

Referring to FIG. 10A, FIG. 10B, and FIG. 10C, graphs depicting various experimental parameters and results for the exemplary hybrid system 900 are illustrated, according to certain embodiments. Variations of air temperature, humidity content, and freshwater production (flux), after each unit of the five bubble dehumidifier units 904 are shown in FIG. 10A, FIG. 10B, and FIG. 10C, respectively. These results demonstrate that the exemplary hybrid system 900 is effective in co-generating freshwater and cooling effect required for air conditioning in a confined space. The air temperature, as recorded after the SGMD unit 902, was reduced from 39° C. to about 25° C., after last stage of the plurality of bubble dehumidifier units 904, without external cooling. Moreover, as can be seen from FIG. 10B, the air humidity ratio (ω) was reduced from 0.046 to 0.02 through the plurality of bubble dehumidifier units 904 of the exemplary hybrid system 900. In the exemplary embodiment depicted in FIG. 10C, the produced freshwater collected from each bubble dehumidifier unit (separately) of the hybrid system 900 was as follows: 40 milliliters per hour (mL/h), 15 mL/h, 11 mL/h, 7.5 mL/h, and 2.5 mL/h, respectively.

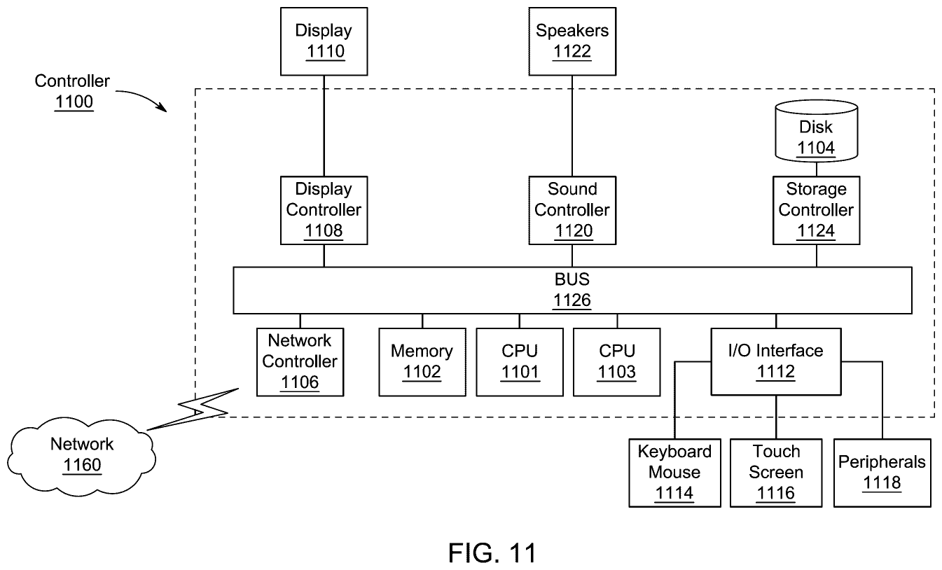

Next, further details of hardware description of a computing environment according to exemplary aspects is described with reference to FIG. 11. In FIG. 11, a controller 1100 is representative of the control unit 108 and the control unit 522 of the hybrid system 100 and the hybrid system 500, respectively. In some embodiments, the controller 1100 is a computing device which includes a CPU 1101 which performs the processes described above/below. In some embodiments, the process data and instructions may be stored in memory 1102. In some embodiments, these processes and instructions may (separately or additionally) be stored on a storage medium disk 1104 such as a hard drive (HDD) or portable storage medium or may be stored remotely.

In general, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

In some embodiments, the claims may be provided as a utility application, background daemon, or component of an operating system, or combination thereof, executing in conjunction with CPU 1101, 1103 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, in some embodiments, CPU 1101 or CPU 1103 may be a Xenon or Core processor from Intel of America or an Opteron processor from AMD of America, or may be other processor types that would be recognized by one of ordinary skill in the art. In some embodiments, the CPU 1101, 1103 may be implemented on an FPGA, ASIC, PLD or using discrete logic circuits, as one of ordinary skill in the art would recognize. In some embodiments, the CPU 1101, 1103 may be implemented as multiple processors cooperatively working in parallel to perform the instructions of the inventive processes described above.

In some embodiments, the computing device in FIG. 11 also includes a network controller 1106, such as an Intel Ethernet PRO network interface card from Intel Corporation of America, for interfacing with network 1160. As may be appreciated, the network 1160 may be a public network, such as the Internet, or a private network such as an LAN or WAN network, or any combination thereof and may also include PSTN or ISDN sub-networks. In some embodiments, the network 1160 may be wired, such as an Ethernet network, or may be wireless such as a cellular network including EDGE, 3G, 4G and 5G wireless cellular systems. In some embodiments, the wireless network may also be Wi-Fi, Bluetooth, or any other wireless form of communication that is known.

In some embodiments, the computing device further includes a display controller 1108, such as a NVIDIA GeForce GTX or Quadro graphics adaptor from NVIDIA Corporation of America for interfacing with display 1110, such as a Hewlett Packard HPL2445w LCD monitor. In some embodiments, a general purpose I/O interface 1112 can interface with a keyboard and/or mouse 1114 as well as a touch screen panel 1116 on or separate from display 1110. In some embodiments, the general purpose I/O interface also connects to a variety of peripherals 1018 including printers and scanners, such as an Office-Jet or Desk-Jet from Hewlett Packard.

In some embodiments, a sound controller 1120 is also provided in the computing device such as Sound Blaster X-Fi Titanium from Creative, to interface with speakers/microphone 1122 thereby providing sounds and/or music.

In some embodiments, the general-purpose storage controller 1124 connects the storage medium disk 1104 with communication bus 1126, which may be an ISA, EISA, VESA, PCI, or similar, for interconnecting all of the components of the computing device. A description of the general features and functionality of the display 1110, keyboard and/or mouse 1114, as well as the display controller 1108, storage controller 1124, network controller 1106, sound controller 1120, and general purpose I/O interface 1112 is omitted herein for brevity as these features are known.

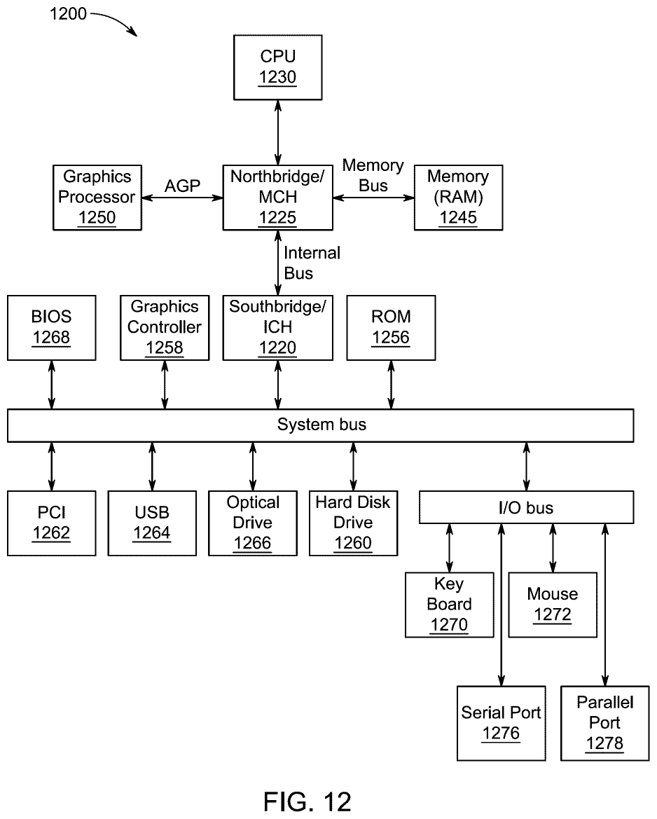

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 12.

FIG. 12 shows a schematic diagram of an exemplary data processing system, according to certain aspects, for performing the functions described herein. The data processing system is an example of a computer in which code or instructions implementing the processes of the illustrative aspects may be located.

In FIG. 12, the exemplary data processing system 1200 employs a hub architecture including a north bridge and memory controller hub (NB/MCH) 1225 and a south bridge and input/output (I/O) controller hub (SB/ICH) 1220. In some embodiments, the central processing unit (CPU) 1230 is connected to NB/MCH 1225. In some embodiments, the NB/MCH 1225 also connects to the memory 1245 via a memory bus and connects to the graphics processor 1250 via an accelerated graphics port (AGP). In some embodiments, the NB/MCH 1225 also connects to the SB/ICH 1220 via an internal bus (such as, a unified media interface or a direct media interface). In some embodiments, the CPU Processing unit 1230 may contain one or more processors and even may be implemented using one or more heterogeneous processor systems.

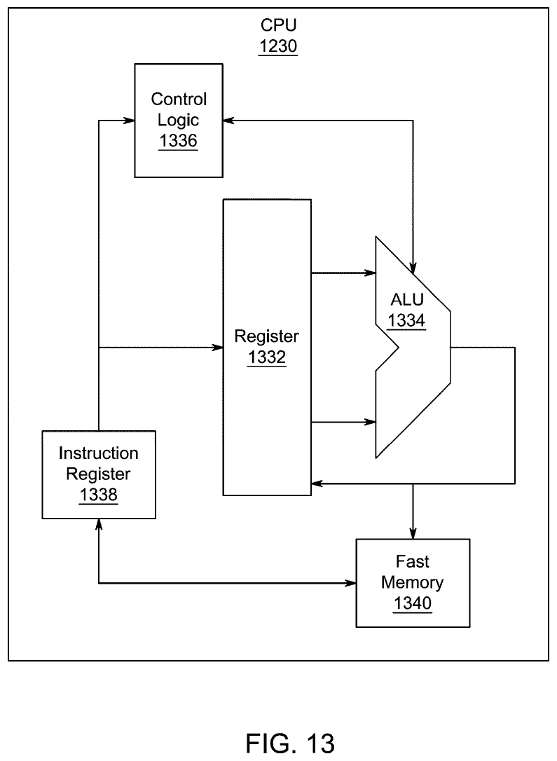

For example, FIG. 13 shows an exemplary embodiment of CPU 1230. In some embodiments, the instruction register 1338 retrieves instructions from the fast memory 1340. At least part of these instructions are fetched from the instruction register 1338 by the control logic 1336 and interpreted according to the instruction set architecture of the CPU 1230. Part of the instructions may also be directed to the register 1332. In some embodiments, the instructions are decoded according to a hardwired method. In some embodiments, the instructions are decoded according to a microprogram that translates instructions into sets of CPU configuration signals that are applied sequentially over multiple clock pulses. After fetching and decoding the instructions, the instructions can be executed using the arithmetic logic unit (ALU) 1334. The ALU 1334 can load values from the register 1332 and perform logical and mathematical operations on the loaded values according to the instructions. The results from these operations may be feedback into the register and/or stored in the fast memory 1340. In some embodiments, the instruction set architecture of the CPU 1330 may use a reduced instruction set architecture, a complex instruction set architecture, a vector processor architecture, a very large instruction word architecture. Furthermore, the CPU 1230 may be based on the Von Neuman model or the Harvard model. In general, the CPU 1230 may be a digital signal processor, an FPGA, an ASIC, a PLA, a PLD, or a CPLD. Further, the CPU 1230 may be an x86 processor by Intel or by AMD; an ARM processor, a Power architecture processor by, e.g., IBM; a SPARC architecture processor by Sun Microsystems or by Oracle; or other known CPU architecture.

Referring again to FIG. 12, in some embodiments, the data processing system 1200 may include that the SB/ICH 1220 is coupled through a system bus to an I/O Bus, a read only memory (ROM) 1256, universal serial bus (USB) port 1264, a flash binary input/output system (BIOS) 1268, and a graphics controller 1258. In some embodiments, PCI/PCIe devices may also be coupled to SB/ICH 1288 through a PCI bus 1262.

In some embodiments, the PCI devices may include, for example, Ethernet adapters, add-in cards, and PC cards for notebook computers. In some embodiments, the hard disk drive 1260 and CD-ROM 1266 may use, for example, an integrated drive electronics (IDE) or serial advanced technology attachment (SATA) interface. In some embodiments, the I/O bus may include a super I/O (SIO) device.

In some embodiments, the hard disk drive (HDD) 1260 and optical drive 1266 may also be coupled to the SB/ICH 1220 through a system bus. In some embodiments, a keyboard 1270, a mouse 1272, a parallel port 1278, and a serial port 1276 may be connected to the system bus through the I/O bus. Other peripherals and devices that may be connected to the SB/ICH 1220 using a mass storage controller such as SATA or PATA, an Ethernet port, an ISA bus, a LPC bridge, SM-Bus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

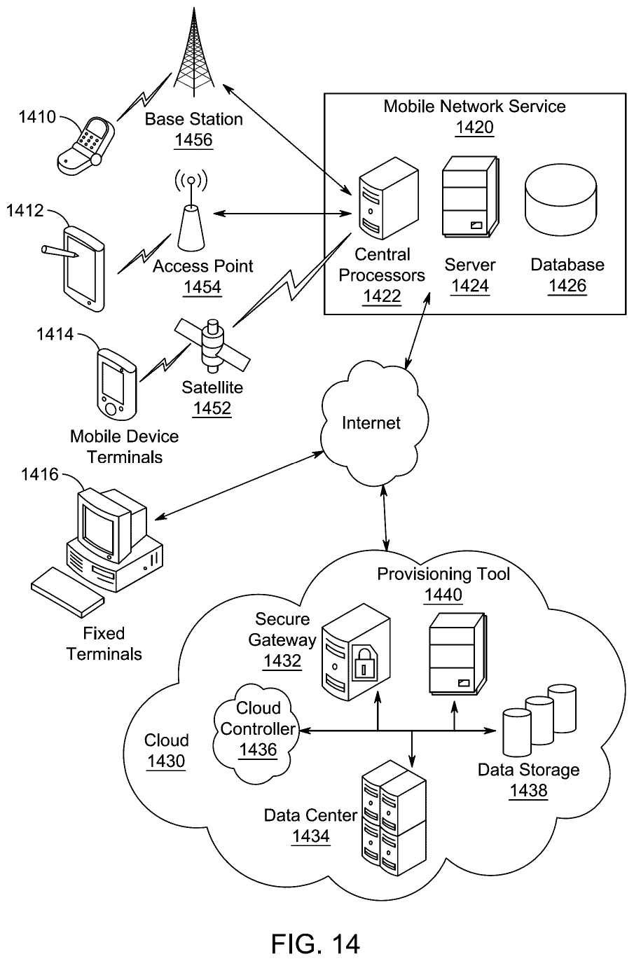

In some embodiments, the functions and features described herein may also be executed by various distributed components of a system. For example, one or more processors may execute these system functions, wherein the processors are distributed across multiple components communicating in a network. In some embodiments, the distributed components may include one or more client and server machines, such as cloud 1430 including a cloud controller 1436, a secure gateway 1432, a data center 1434, data storage 1438 and a provisioning tool 1440, and mobile network services 1420 including central processors 1422, a server 1424 and a database 1426, which may share processing, as shown by FIG. 14, in addition to various human interface and communication devices (e.g., display monitors 1416, smart phones 1410, tablets 1412, personal digital assistants (PDAs) 1414). In general, the network can be any suitable type of network, such as a private network, such as a LAN, satellite 1452 or WAN 1454, or be a public network, may such as the Internet. In some embodiments, input to the system may be received via direct user input and received remotely either in real-time or as a batch process.

The hybrid system described herein may be advantageous for, for example, having an enhanced overall energy efficiency. Such enhancement may be associated with the integration of low energy consuming processes such as desalination by the SGMD unit and dehumidification by the bubble dehumidifier unit. Further, the levelized cost of the process may be reduced by combining two operations into the hybrid system, saving on equipment and operational costs. By leveraging dehumidification capabilities of the bubble dehumidifier unit, the hybrid system may provide space conditioning facilities in addition to freshwater generation, making it particularly suitable for applications in warm climates where both clean water and cooling are in high demand.

Generally, the hybrid systems may be used for the treatment of wastewater, and simultaneously providing space conditioning. The hybrid freshwater generation and air conditioning systems of the present disclosure may find wide-ranging applications across various industries, as well as in specific processes requiring water treatment and temperature regulation. For example, the hybrid systems may be employed to desalinate seawater, thereby producing freshwater for various uses, including drinking, irrigation, and industrial processes. The hybrid systems may be used for the purification of water used in textile manufacturing processes, aiding in the removal of dyes and other contaminants. The hybrid systems may play a crucial role in the purification of water used in chemical synthesis and pharmaceutical production, helping maintain the purity of the products and adhere to stringent regulations. The hybrid systems may also be utilized in the separation of azeotropic aqueous mixtures, such as the separation of alcohol and water mixtures, enhancing the efficiency of industrial processes. The hybrid systems may find applications in mining or petroleum and natural gas drilling or other processes that may use or generate salt-containing liquids such as brines or other contaminated liquid, contributing to resource conservation and environmental protection. The hybrid systems may be used in various commercial and non-commercial settings to provide low-cost energy efficient air conditioning to a defined space. Such air conditioning can be provided in conjunction with the water treatment, such as for mine or petroleum and natural gas drilling facilities, textile manufacturing facilities, chemical refinery facilities, and the like. The hybrid systems may be advantageous for reducing energy usage and/or environmental impact, and possibly thereby aiding in sustainability efforts.

The above-described hardware description is a non-limiting example of corresponding structure for performing the functionality described herein.

Numerous modifications and variations of the present disclosure are possible in light of the above teachings. It is therefore to be understood that within the scope of the appended claims, the present invention may be practiced otherwise than as specifically described herein.

1. A hybrid freshwater generation and air conditioning system, comprising
a sweeping gas membrane distillation unit, comprising
a liquid side comprising a liquid inlet, a liquid outlet, and a porous hydrophobic membrane, and
a vapor side comprising a gas inlet and a gas outlet, wherein the liquid side is separated from the vapor side by the porous hydrophobic membrane; and
a bubble dehumidifier unit, comprising
a gas inlet connected to the gas outlet of the vapor side of the sweeping gas membrane distillation unit,
a gas outlet,
a freshwater inlet,
a freshwater outlet,
a recirculation outlet,
a recirculation cooler, and
a recirculation inlet;
wherein the hybrid freshwater generation and air conditioning system is configured to contain a saltwater in the liquid side and pass a gas over the porous hydrophobic membrane in the vapor side of the sweeping gas membrane distillation unit to produce a humidified gas,
the bubble dehumidifier unit is configured to pass the humidified gas through a freshwater in the form of bubbles, thereby producing a dehumidified gas, and
the bubble dehumidifier unit is configured to recirculate the freshwater through the recirculation outlet to the recirculation cooler, cool the freshwater to produce a cooled water, and provide the cooled water to the freshwater contained in the bubble dehumidifier unit.

2. The hybrid freshwater generation and air conditioning system of claim 1, wherein the recirculation cooler is at least one selected from a thermoelectric cooler, a cooling tower, and a heat exchanger.

3. The hybrid freshwater generation and air conditioning system of claim 1, wherein the recirculation inlet comprises a spray nozzle disposed at a top of the bubble dehumidifier unit and is configured to spray the cooled water into the bubble dehumidifier unit in the form of a cone-shaped flow of droplets such that the cooled water contacts the dehumidified gas, and
wherein the gas inlet is connected to a gas dispersion device at a bottom of the bubble dehumidifier unit, wherein the gas dispersion device is a circular tube disposed flat on the bottom of the bubble dehumidifier unit and has a plurality of inwardly facing aperture configured to release a rising column of the humidified gas into the freshwater.

4. The hybrid freshwater generation and air conditioning system of claim 1, further comprising a photovoltaic electricity generating unit configured to provide electricity to the hybrid freshwater generation and air conditioning system.

5. The hybrid freshwater generation and air conditioning system of claim 1, further comprising a dehumidified air cooler configured to cool the dehumidified gas exiting the bubble dehumidifier unit thereby producing a cooled gas.

6. The hybrid freshwater generation and air conditioning system of claim 5, wherein the dehumidified air cooler comprises an auxiliary freshwater tank configured to collect freshwater produced by the cooling of the dehumidified gas.

7. The hybrid freshwater generation and air conditioning system of claim 1, wherein the system comprises a plurality of bubble dehumidifier units connected in series such that the gas inlet of a first bubble dehumidifier unit is connected to the gas outlet of the vapor side of the sweeping gas membrane distillation unit and the gas inlet of each other bubble dehumidifier unit is connected to the gas outlet of a preceding bubble dehumidifier unit.

8. The hybrid freshwater generation and air conditioning system of claim 1, wherein the bubble dehumidifier unit comprises a vapor trap disposed at a top of the bubble dehumidifier unit.

9. The hybrid freshwater generation and air conditioning system of claim 8, wherein the vapor trap is configured to be cooled to a temperature below a temperature of the dehumidified gas.

10. The hybrid freshwater generation and air conditioning system of claim 1, wherein the gas is air.

11. A hybrid freshwater generation and air conditioning system, comprising
a sweeping gas membrane distillation unit, comprising
a liquid side comprising a liquid inlet, a liquid outlet, and a porous hydrophobic membrane, and
a vapor side comprising a gas inlet and a gas outlet, wherein the liquid side is separated from the vapor side by the porous hydrophobic membrane; and
a plurality of bubble dehumidifier units, each comprising
a gas inlet connected to the gas outlet of the vapor side of the sweeping gas membrane distillation unit,
a gas outlet,
a freshwater inlet, and
a freshwater outlet;
wherein the hybrid freshwater generation and air conditioning system is configured to contain a saltwater in the liquid side and pass a gas over the porous hydrophobic membrane in the vapor side of the sweeping gas membrane distillation unit to produce a humidified gas,
each bubble dehumidifier unit is configured to pass the humidified gas through a freshwater in the form of bubbles, thereby producing a dehumidified gas,
the plurality of bubble dehumidifier units connected in series such that the gas inlet of a first bubble dehumidifier unit is connected to the gas outlet of the vapor side of the sweeping gas membrane distillation unit and the gas inlet of each other bubble dehumidifier unit is connected to the gas outlet of a preceding bubble dehumidifier unit, and
each bubble dehumidifier unit contains a different amount of freshwater, the amount of freshwater being greater than a subsequent bubble dehumidifier unit in series and less than a preceding bubble dehumidifier unit in series.

12. The hybrid freshwater generation and air conditioning system of claim 11, further comprising a photovoltaic electricity generating unit configured to provide electricity to the hybrid freshwater generation and air conditioning system.

13. The hybrid freshwater generation and air conditioning system of claim 11, further comprising a dehumidified air cooler configured to cool the dehumidified gas exiting a final bubble dehumidifier unit thereby producing a cooled gas.

14. The hybrid freshwater generation and air conditioning system of claim 13, wherein the dehumidified air cooler comprises an auxiliary freshwater tank configured to collect freshwater produced by the cooling of the dehumidified gas.

15. The hybrid freshwater generation and air conditioning system of claim 11, wherein each bubble dehumidifier unit further comprises
a recirculation outlet,
a recirculation cooler, and
a recirculation inlet; and
each bubble dehumidifier unit is configured to recirculate the freshwater through the recirculation outlet to the recirculation cooler, cool the freshwater to produce a cooled water, and provide the cooled water to the freshwater contained in the bubble dehumidifier unit.

16. The hybrid freshwater generation and air conditioning system of claim 15, wherein the recirculation cooler is at least one selected from a thermoelectric cooler, a cooling tower, and a heat exchanger.

17. The hybrid freshwater generation and air conditioning system of claim 15, wherein the recirculation inlet comprises a spray nozzle disposed at a top of the bubble dehumidifier unit and is configured to spray the cooled water into the bubble dehumidifier unit such that the cooled water contacts the dehumidified gas.

18. The hybrid freshwater generation and air conditioning system of claim 11, wherein each bubble dehumidifier unit comprises a vapor trap disposed at a top of the bubble dehumidifier unit.

19. The hybrid freshwater generation and air conditioning system of claim 18, wherein the vapor trap is configured to be cooled to a temperature below a temperature of the dehumidified gas.

20. The hybrid freshwater generation and air conditioning system of claim 11, wherein the gas is air.
